(19) United States
(12) Patent Application Publication
(10) Pub. No.: US 2026/0289166 A1
(43) Pub. Date: Sep. 24, 2026

(54) SYSTEM

(71) Applicant: SoftBank Group Corp., Tokyo (JP)

(72) Inventor: Mitsuki TERADA, Tokyo (JP)

(73) Assignee: SoftBank Group Corp., Tokyo (JP)

(21) Appl. No.: 19/563,170

(22) Filed: Mar. 11, 2026

(30) Foreign Application Priority Data
Mar. 19, 2025 (JP) 2025-045001

(51) Int. Cl. G06F 40/40; G06F 40/103; G06F 40/186; G06F 40/253; G06F 40/289; G06F 40/35; G06N 3/0455; G06N 3/0475; H04L 51/212

(52) U.S. Cl. CPC G06F 40/40; G06F 40/103; G06F 40/186; G06F 40/253; G06F 40/289; G06F 40/35; G06N 3/0455; G06N 3/0475; H04L 51/212

(57) ABSTRACT

A system includes a processor that is configured to analyze user characteristics and a communication history by using a natural language processing technique and an emotion analysis engine so as to recognize an emotional state of a user, create a prompt sentence for input to a generative AI model on the basis of an analysis result and the emotional state, and transmit a reply generated by the generative AI model in place of the user.

### CROSS-REFERENCE TO RELATED APPLICATION

This application is based on and claims priority under 35 USC 119 from Japanese Patent Application No. 2025-045001 filed on Mar. 19, 2025, the disclosure of which is incorporated by reference herein.

### BACKGROUND

### Technical Field

The present disclosure relates to a system.

Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional communication support systems and messaging applications merely provide simple functionalities such as fixed template responses, keyword-based auto-replies, or notification management, and thus fail to generate highly personalized replies that reflect a user's emotional state and communication characteristics. As a result, when a user is busy, fatigued, or otherwise unable to respond carefully, the quality and continuity of communication with a counterpart, for example a counterpart user matched via a dating application, are significantly degraded. In particular, existing systems do not sufficiently analyze a combination of user characteristics, detailed communication histories, and real-time emotional states through advanced natural language processing and emotion analysis, and therefore cannot construct appropriate prompts for generative AI models that would allow contextually suitable and user-like replies to be produced. There is a need for a system that accurately recognizes a user's emotional state from communication logs, converts analysis results into optimized prompts for generative AI models, and automatically transmits replies in place of the user in a manner that maintains both the user's communication style and the quality of interaction with the counterpart user.

### SUMMARY

In order to solve the above-described problems, the present invention provides a system comprising a processor, wherein the processor is configured to analyze user characteristics and a communication history by using a natural language processing technique and an emotion analysis engine so as to recognize an emotional state of a user, to create a prompt sentence for input to a generative AI model on the basis of an analysis result and the emotional state, and to transmit a reply generated by the generative AI model in place of the user. In the system of the present invention, the processor is further configured to analyze the user characteristics and the communication history by using an artificial intelligence technique and to analyze data by utilizing the natural language processing technique, thereby enabling extraction of user-specific features and conversation patterns from large-scale and diverse communication histories. Furthermore, in the system of the present invention, the processor is configured to create the prompt for the generative AI model and perform an appropriate reply in order to respond, in place of the user, to communications with a counterpart user matched via a dating application, so that automatic replies can be generated and transmitted while reflecting the user's style and emotional state, thereby maintaining natural and continuous communication even when the user is not able to respond personally.

The term “system” refers to an apparatus or combination of hardware and software components including at least one processor and, optionally, memory, communication interfaces, and storage, configured to execute the processes described in the present specification and claims.

The term “processor” refers to any hardware device or combination of devices capable of executing instructions, including but not limited to a central processing unit (CPU), a graphics processing unit (GPU), a digital signal processor (DSP), an application-specific integrated circuit (ASIC), a field-programmable gate array (FPGA), or a microcontroller, whether implemented on a single machine or distributed across multiple machines.

The term “user” refers to a human operator who utilizes the system to perform communication with one or more counterpart users via an electronic communication service, including but not limited to a dating application.

The term “user characteristics” refers to information representing attributes or behavioral tendencies of the user, including but not limited to profile information, preferences, communication style, frequently used expressions, favored topics, and historical patterns of interaction.

The term “communication history” refers to a record of past communications associated with the user, including but not limited to messages sent by the user, messages received by the user, timestamps, counterpart identifiers, and contextual metadata related to such communications.

The term “natural language processing technique” refers to any computational method or algorithm for processing, analyzing, understanding, or generating human language, including but not limited to tokenization, part-of-speech tagging, syntactic parsing, semantic analysis, topic extraction, and text classification.

The term “emotion analysis engine” refers to a software and/or hardware module configured to estimate or classify an emotional state of the user from text, voice, or other communication-related data, using methods such as sentiment analysis, affective computing, or emotion classification models.

The term “emotional state” refers to an inferred or estimated psychological condition of the user, including but not limited to emotions such as happiness, sadness, anger, anxiety, excitement, or calmness, and may be represented as categorical labels, continuous scores, or multidimensional vectors.

The term “analysis result” refers to data or parameters obtained by analyzing the user characteristics and the communication history, and optionally the emotional state, including but not limited to detected topics, communication patterns, style indicators, and inferred preferences of the user.

The term “prompt sentence” refers to text or structured input data generated by the processor for providing instructions, context, or constraints to a generative AI model, so that the generative AI model generates a reply appropriate to the user's characteristics, communication history, and emotional state.

The term “generative AI model” refers to an artificial intelligence model, such as a large language model or other generative model, configured to generate natural language text or other content in response to an input prompt.

The term “reply” refers to a response message generated by the generative AI model based on the prompt sentence and intended to be transmitted to a counterpart user in the context of an electronic communication session.

The term “artificial intelligence technique” refers to any computational technique used for learning, inference, or decision-making, including but not limited to machine learning, deep learning, neural networks, statistical models, and rule-based expert systems.

The term “counterpart user” refers to another human user who communicates with the user through the communication service, including a user who is matched with the user via a dating application.

The term “dating application” refers to a software application or online service that facilitates meeting, matching, or communication between users for romantic, social, or relationship purposes, and that provides messaging or chat functions for such users.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

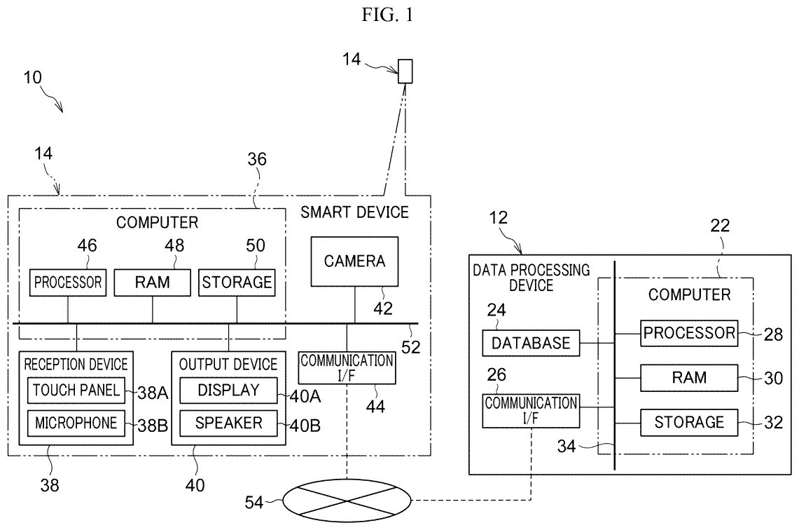

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

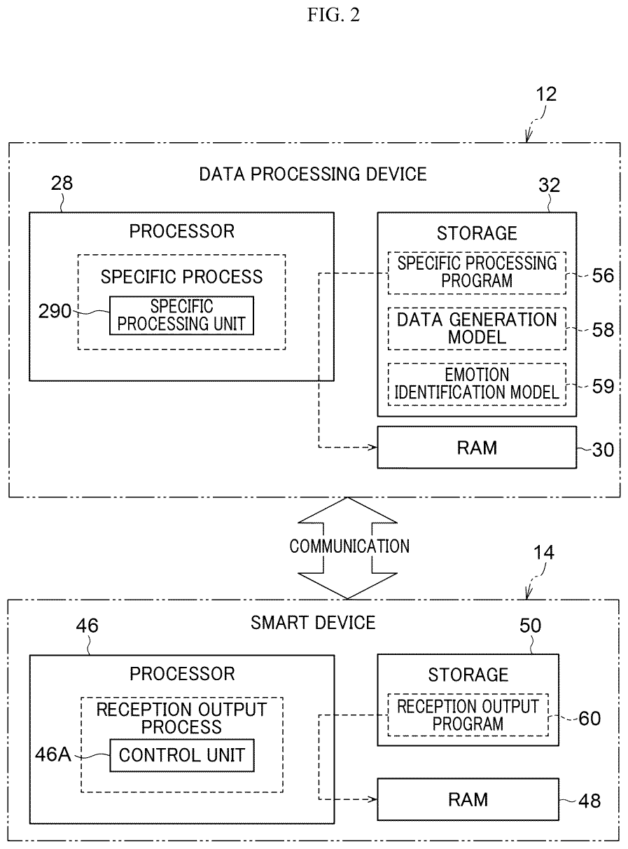

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional online communication systems, including systems used in matching services and other interactive platforms, generally require a human user to manually compose responses based on personal attributes, conversational history, and current context. Although some systems employ basic template responses or rule-based suggestion engines, these systems do not perform sufficiently fine-grained analysis of user-specific communication patterns, emotional states, and evolving conversational topics. As a result, suggested responses are often generic, poorly aligned with the user's true interests or personality, and may inadvertently conflict with the user's current emotional tone or the conversational intent of the communication partner.

Further, existing systems that make use of machine learning models or generative artificial intelligence models typically accept only shallow prompt inputs that are manually specified or statically configured. Such systems do not automatically construct rich prompt sentences that integrate multi-dimensional information, including user attribute information, past communication information, inferred topic clusters, and dynamically detected emotional states. This leads to suboptimal conditioning of the generative models, which in turn degrades the relevance, safety, and naturalness of the generated responses.

Additionally, there is a technical problem in efficiently transforming unstructured communication logs into structured representations that can be reliably consumed by advanced generative models. Without automated extraction of keyword sets and topic groups, and without vector-based analysis and clustering, a server must either rely on large raw text inputs (increasing latency and computational cost) or accept information loss in simplified prompts. This results in poor use of network bandwidth, increased processing time on both client and server, and an overall degradation of system scalability and responsiveness.

There is also a further technical challenge in ensuring that generated replies conform to safety policies, content restrictions, and platform-specific communication rules at scale. Traditional moderation methods typically operate as a separate, downstream process or rely on manual review, which introduces latency and cannot be easily personalized to each user's profile, emotional state, and conversational context. This separation between generation and moderation increases system complexity and can cause inconsistent behavior across different devices and sessions.

Accordingly, there is a need for a computer-implemented system that (i) automatically analyzes user attribute information and past communication information using advanced natural language processing, (ii) infers user emotional states and topic structures to construct high-quality prompt sentences for a generative AI model, (iii) integrates vector-based representation and clustering to dynamically select conversation themes, and (iv) performs integrated, automated filtering and formatting of generated responses. By addressing these technical issues in how conversational data is processed, represented, and utilized within the server, the system can improve the functioning of the computer itself, including improved efficiency of data processing, reduced network overhead, and enhanced reliability and consistency of automated response generation.

The specific processing by the specific processing unit 290 of the data processing device 12 in Example 1 is realized by the following means.

The present invention provides a server comprising a processor and a storage device, the processor being configured to acquire, based on user identification information, user attribute information and past communication information stored in the storage device; to analyze the past communication information by using a natural language processing algorithm to divide the past communication information into linguistic units and part-of-speech units, to perform occurrence frequency analysis and removal of unnecessary terms to extract a keyword set and a topic group indicating user interests, and to recognize a user emotional state by using an emotion analysis algorithm; to generate, based on the keyword set, the topic group, the user emotional state, and latest message content from a communication partner, a prompt sentence including conditions relating to a user personality tendency, a conversation context, a desired writing style, and a response length, by performing template processing, and to configure the prompt sentence as input data for a generative artificial intelligence model; to convert the past communication information into a vector representation by using an embedding model, to derive the topic group by using a clustering method, and to dynamically select conversation theme information to be included in the prompt sentence based on the topic group; to transmit the prompt sentence to the generative artificial intelligence model via a network-based application programming interface and to receive a response candidate text obtained from the generative artificial intelligence model; and to perform filtering processing and formatting processing on the response candidate text based on a content restriction rule or a safety determination algorithm to determine a substitute response message for the user, and to transmit the substitute response message to a communication terminal for delivery to the communication partner via an online communication service. This enables the server to automatically transform unstructured conversational logs into structured, context-rich prompt sentences, to efficiently condition a generative model for user-specific and context-aware response generation, to reduce computational and network overhead through vector-based topic derivation and dynamic theme selection, and to provide consistent, policy-compliant, and emotionally aligned automated replies that improve the overall performance and reliability of computer-implemented communication systems.

The term “user identification information” refers to information used by the server to uniquely identify a user, such as an identifier, account ID, or other machine-readable code that allows retrieval of associated data from a storage device.

The term “user attribute information” refers to structured or semi-structured data describing characteristics of a user, including demographic attributes, preference attributes, interest attributes, personality-related attributes, and profile text, which are stored in association with the user identification information.

The term “past communication information” refers to data representing one or more historical communications associated with a user, including message text, timestamps, sender and receiver identifiers, and any metadata recorded by an online communication service.

The term “storage device” refers to a hardware component or combination of hardware components configured to store digital data, including non-transitory computer-readable media such as magnetic storage, optical storage, or semiconductor memory.

The term “natural language processing algorithm” refers to a computer-implemented procedure that operates on human language text to perform processing such as tokenization, part-of-speech tagging, syntactic parsing, named entity recognition, or keyword extraction.

The term “linguistic units” refers to segments of natural language text obtained by processing, including words, subwords, morphemes, or punctuation marks, which are treated as basic analysis units by the natural language processing algorithm.

The term “part-of-speech units” refers to linguistic units that have been annotated with grammatical categories such as noun, verb, adjective, or adverb, as determined by a part-of-speech tagging process.

The term “occurrence frequency analysis” refers to a computational process in which the number of occurrences of each linguistic unit or group of linguistic units is counted and analyzed within the past communication information.

The term “unnecessary terms” refers to linguistic units that are determined to be non-informative or low-importance for user interest identification, such as stop words, common function words, or frequently occurring generic terms.

The term “keyword set” refers to a collection of one or more keyword elements extracted from past communication information, where each keyword element is indicative of a topic, interest, or preference associated with a user.

The term “topic group” refers to a collection of one or more topics derived from past communication information, where each topic represents a higher-level concept or theme composed of related keywords or semantic clusters.

The term “user interests” refers to subject matters, activities, or entities that are inferred to be favored or frequently referenced by a user, as indicated by the keyword set and the topic group.

The term “emotion analysis algorithm” refers to a computer-implemented procedure that processes text or related signals to infer an emotional state of a user, such as happiness, sadness, excitement, or neutrality.

The term “user emotional state” refers to an inferred psychological condition or affective status of a user at a given time, as determined by the emotion analysis algorithm based on past communication information or current communication context.

The term “latest message content” refers to text data or equivalent representation of the most recent message received from a communication partner in an online communication session.

The term “communication partner” refers to an entity, such as another user or an automated agent, that exchanges messages with a user through the online communication service.

The term “prompt sentence” refers to a textual input sequence prepared for a generative artificial intelligence model, the textual input sequence including instructions, context information, and conditions that guide generation of response text by the model.

The term “user personality tendency” refers to a set of characteristics or behavioral patterns associated with a user, such as introversion, extroversion, politeness level, or preferred communication style, which can be reflected in generated responses.

The term “conversation context” refers to information describing the state of an ongoing conversation, including past messages, topics, interaction history, and the current intent or question being addressed.

The term “desired writing style” refers to one or more constraints or preferences regarding linguistic manner, such as formality, tone, level of detail, or humor, that are to be applied to generated text.

The term “response length” refers to a constraint or preference regarding the amount of content to be generated by the generative artificial intelligence model, such as a number of tokens, sentences, or characters.

The term “template processing” refers to a procedure in which predefined textual patterns with variable placeholders are filled or instantiated with specific data, such as keywords, topics, and emotional states, to construct a prompt sentence.

The term “input data for a generative artificial intelligence model” refers to digital data, including text and optional control parameters, supplied to a generative model to cause the model to produce one or more output sequences.

The term “generative artificial intelligence model” refers to a machine learning model configured to generate content, such as text, in response to input data, and may include a large language model based on a neural network architecture.

The term “embedding model” refers to a computational model that maps text or other discrete symbols to numerical vector representations in a continuous space, such as word embeddings or sentence embeddings.

The term “vector representation” refers to a numerical representation of text or other data in the form of one or more values in a multi-dimensional space, produced by an embedding model.

The term “clustering method” refers to an unsupervised learning algorithm that groups similar vector representations into clusters, thereby identifying topic groups or related themes.

The term “conversation theme information” refers to data describing one or more principal themes or topics to be reflected in a generated response, derived from topic groups or user interests.

The term “network-based application programming interface” refers to an interface that allows software components to communicate over a communication network by exchanging structured requests and responses.

The term “response candidate text” refers to one or more text sequences produced by the generative artificial intelligence model in response to the prompt sentence before any post-processing or selection is applied.

The term “content restriction rule” refers to a rule set specifying constraints on allowable content in generated responses, including prohibitions on certain terms, topics, or behaviors in accordance with policy or regulation.

The term “safety determination algorithm” refers to a computer-implemented procedure that evaluates generated text for compliance with safety policies, such as avoidance of harmful, abusive, or inappropriate content.

The term “filtering processing” refers to a procedure that modifies, removes, or rejects portions of the response candidate text based on the content restriction rule or the safety determination algorithm.

The term “formatting processing” refers to a procedure that adjusts the structure or appearance of response text, including capitalization, punctuation, spacing, or segmentation into sentences or paragraphs.

The term “substitute response message” refers to a finalized text message that has been generated, filtered, and formatted by the server and is intended to be transmitted in place of a message manually composed by the user.

The term “communication terminal” refers to an endpoint device, such as a mobile device, a computer, or another network-connected apparatus, that sends and receives messages through the online communication service.

The term “online communication service” refers to a network-based service or platform that enables users to exchange digital messages, including text messages, in real time or near real time.

In one embodiment, a server cooperates with one or more terminals operated by users to provide context-aware automatic response generation using a generative AI model. The server includes at least one processor, a main memory, a non-transitory storage device, and a network interface. The storage device stores user attribute information, past communication information, program modules implementing natural language processing, emotion analysis, embedding and clustering, prompt sentence generation, and generative AI model interfacing, as well as configuration data defining content restriction rules and safety determination algorithms.

The server operates on general-purpose hardware such as a multi-core CPU, volatile memory, and a solid-state storage device, and runs an operating system such as a Unix-like system. The server executes software components written in a general-purpose programming language, such as an interpreted or compiled language, and uses external libraries implementing natural language processing functions, such as tokenization, part-of-speech tagging, and named entity recognition, and embedding models such as word-embedding or sentence-embedding models. The server communicates with an external generative AI model executed on remote computing hardware including graphical processing units through a network-based application programming interface.

The terminal is, for example, a smartphone, tablet, or personal computer. The terminal includes an input device, a display device, a wireless or wired communication interface, and a processor. The terminal executes a client application for an online communication service, such as a matching service, and provides a graphical user interface that allows the user to log in, browse conversations, view suggested responses generated by the server, and selectively edit and send those responses. The terminal exchanges structured messages with the server via a secure communication protocol.

The user operates the terminal to access the online communication service and to trigger generation of an automated reply. The user may select a conversation, enable an “AI suggestion” mode, and specify optional parameters such as a desired tone or maximum response length. The user can review the suggestion, make changes manually, or request regeneration.

The server stores user attribute information in a tabular or document-oriented data structure. For example, the server associates a user identifier with fields such as age range, region, free-text profile description, explicit interests (for example, “movies,” “music,” “travel”), and high-level personality tags (for example, “introverted,” “outgoing”). The server stores past communication information, including message text, timestamps, sender identifiers, recipient identifiers, and conversation identifiers, in a relational table or equivalent data structure. The server indexes this information to allow efficient retrieval by user identifier and conversation identifier.

The server uses a natural language processing module to process the past communication information. The server converts each stored message into a sequence of linguistic units by performing tokenization. The server tags each linguistic unit with a part-of-speech category by applying a trained statistical or neural tagging model. The server removes unnecessary terms using a predefined or learned stop-word list and uses occurrence frequency analysis to compute term frequencies or term frequency-inverse document frequency scores. The server thereby extracts a keyword set composed of nouns, noun phrases, and significant verbs that characterize topics frequently addressed by the user. Examples of extracted keywords include “sci-fi movies,” “live concerts,” “coffee shops,” and “trips to historical cities.”

The server further uses an embedding model to compute vector representations of sentences or messages. In one embodiment, the server uses a neural embedding model with multiple layers that maps each input sentence to a fixed-dimensional vector. The server aggregates a set of such vectors representing the user's historical messages and applies a clustering method, such as k-means clustering or hierarchical clustering, to partition the vectors into clusters. Each cluster corresponds to a topic group, such as “movies,” “music events,” or “travel planning.” This clustering is not a simple manual categorization; the server uses numerical optimization to minimize intra-cluster distances in the embedding space, thereby automatically discovering latent conversation themes that a human might not explicitly define.

The server uses an emotion analysis module to infer a user emotional state. The server can implement this module as a neural classifier model that operates on message text and outputs a probability distribution over emotion labels such as “happy,” “sad,” “angry,” “excited,” or “neutral.” The server extracts features such as word n-grams, sentence-level embeddings, punctuation patterns, and emoji usage and feeds these features into a neural network with multiple layers, such as a feed-forward or recurrent architecture. During training, the server or an offline training system uses a labeled dataset of messages, an error function such as cross-entropy loss, and a gradient-based optimization algorithm to adjust model weights. The trained model is then deployed on the server as part of the emotion analysis module. In operation, the server supplies the user's recent messages to this module and obtains the most likely emotion label and associated confidence scores as the current user emotional state.

The server combines the keyword set, the topic groups, and the user emotional state with the latest message content from a communication partner. The server forms a conversation context data structure that includes: (i) a list of top-ranked user interests derived from the keyword set and topic groups, (ii) the inferred personality tendency of the user, which the server can infer from long-term patterns in the user's messages, such as average response length, prevalence of first-person pronouns, and use of emotive adjectives, (iii) the textual content of the latest partner message, and (iv) optional parameters such as a desired writing style and response length selected by the user or preset by system settings.

The server generates a prompt sentence for the generative AI model by performing template processing. The server maintains one or more prompt templates with placeholder fields for user interests, personality descriptors, conversation themes, partner message text, and generation constraints. The server selects an appropriate template based on the conversation context, then substitutes actual values into the placeholders. For example, the server may generate a prompt sentence such as:
“User profile:
   Interests: sci-fi movies, rock concerts, traveling to places like Kyoto, visiting coffee shops.
   Personality: a bit introverted at first, but friendly and curious.
Partner's latest message:
‘Hey, what do you usually do on weekends? Maybe we could catch a movie sometime.’
Task:
Based on the user's interests and personality, generate a natural, friendly, and slightly flirty reply in English. The reply should be 2-3 sentences, mention movies, and invite further conversation.”

In another example, the server may generate a prompt sentence such as:
“User profile: enjoys movies (especially sci-fi), likes live rock concerts, and is planning a trip to Kyoto. Partner's message: ‘I love music too! What kind of concerts do you go to?’ Please generate a natural, flirty but polite reply that matches the user's interests.”

The server can further add explicit constraints regarding tone, prohibited content categories, or length limits directly into the prompt sentence. This structured inclusion of multi-dimensional information causes the generative AI model to operate on a greatly enriched input that is not achievable with simple manually-entered prompts. As a result, the generative AI model can use its internal neural architecture more efficiently, converging on a narrower subspace of potential responses and reducing the number of tokens and intermediate computations needed.

The server communicates with the generative AI model via a network-based application programming interface. The generative AI model is, for example, a large language model that uses a transformer architecture with multiple attention layers, feed-forward layers, and layer normalization. The server specifies, as part of the request, parameters such as a temperature value controlling randomness, a maximum number of output tokens, and a top-k or top-p sampling strategy controlling token selection. The server transmits the prompt sentence and the generation parameters to the external model host, which performs forward passes through its neural network layers, applying attention mechanisms and linear transformations based on previously trained weights. During training, this type of model uses a loss function such as negative log likelihood, mini-batch gradient descent, and regularization techniques, but this training typically occurs on separate infrastructure. At inference time, the server only sends the prompt sentence and receives the response candidate text, but the shape and size of the prompt sentence directly affect computational cost and quality of the generated text.

The server receives the response candidate text as part of a structured response and parses the response body to extract the generated text sequence. The server then applies a content restriction module and a safety determination algorithm. The content restriction module uses rule-based filters, pattern matching, or additional classification models to detect sequences that match predetermined prohibited categories such as explicit personal contact information, offensive language, or discriminatory expressions. The safety determination algorithm may use a smaller neural classifier that takes the response candidate text as input and outputs a risk score. The server compares this risk score with one or more thresholds and, if necessary, modifies the response, removes hazardous segments, or rejects the entire candidate. This integrated processing differs from manual moderation because the server enforces machine-actionable policies in real time, in a deterministic sequence associated with specific safety constraints.

The server also applies formatting processing, such as normalizing white space, adjusting capitalization, ensuring sentences end with valid punctuation, and truncating the text if it exceeds a specified length. The server then determines the final substitute response message and associates it with the corresponding conversation and user identifier.

The server transmits the substitute response message to the terminal via a secure communication channel. The terminal displays the substitute response message to the user within a dedicated area, such as a text input field or suggestion bubble. The user can choose to send the message as is, modify it, or discard it. When the user issues a send command, the terminal transmits the final message (which may have been edited by the user) to the online communication service backend. The server stores this final message in the past communication information, thereby closing the loop and providing new data that may influence future analysis and response generation.

This system provides several technical effects that improve computer technology rather than merely automating a human mental process. The server uses specific data structures (keyword sets, topic groups, vector embeddings, and prompt templates) and specific algorithms (tokenization, part-of-speech tagging, clustering, neural emotion classification, content filtering) that reduce the dimensionality and redundancy of the text data before sending it to the generative AI model. By doing so, the server reduces the size of the prompt sentence and avoids transmitting entire raw histories, thereby lowering communication load over the network and reducing inference time on the model host. The extraction and clustering of topics into a compact representation lower memory bandwidth usage and cache misses in the external model, because the model processes fewer, more informative tokens.

Further, the server improves precision and consistency of the generated responses by tying the generative process to structured user interests and emotional states rather than free-form manual prompts. The generation of a structured prompt sentence that includes explicit instructions and constraints enables the generative AI model to produce responses that more consistently align with the user's profile and context, thereby reducing the need for repeated regenerations and manual corrections. This reduces server-side computational load and client-side battery usage and reduces overall latency perceived by the user.

The server also improves data management by continuously logging, in an organized manner, prompt sentences, response candidate texts, and safety decisions, which can be used to retrain or fine-tune local classification modules and update content restriction rules. This closed feedback loop improves classification accuracy for emotion detection and safety determination over time.

The server employs a processing pipeline and data flow that differ from conventional rule-based templating or naive generative AI usage. Instead of directly passing conversation text to a model, the server performs a non-standard combination of NLP preprocessing, vector-based clustering, emotion classification, and template-based prompt sentence assembly. This non-conventional sequence of operations creates intermediate representations (keywords, topic clusters, emotional states) that are specifically designed to optimize generative model performance and to ensure safety and personalization without requiring manual oversight. Because the system relies on quantitative similarity in embedding space and algorithmic clustering, the generated responses can incorporate nuanced patterns in user communication that are not easily captured by human-defined rules.

In another embodiment, the server may host a local generative AI model instead of accessing a remote model. In this case, the server executes a neural network implementation, such as a transformer network with multiple encoder and decoder layers, on its own hardware. The server stores model weights in the storage device and loads them into memory upon startup. The server then performs tokenization, positional encoding, multi-head attention, and feed-forward operations locally. The use of the structured prompt sentence and preprocessed context in this local scenario similarly reduces computational load because the model operates on shorter sequences while still receiving high-level semantic and emotional cues, which can reduce the number of attention computations and matrix multiplications required per generated token.

In a further embodiment, the server may vary the clustering method or embedding model based on resource constraints. For example, the server may switch between a high-dimensional embedding and a lower-dimensional embedding based on current processor load. This adaptive selection of embedding resolution can further optimize throughput and response time, leveraging the same overall pipeline but trading off granularity for speed.

In yet another embodiment, the terminal may perform a subset of preprocessing tasks, such as lightweight tokenization or client-side caching of recent messages. The server then only performs heavy tasks such as vectorization, clustering, and generative model interfacing, thereby offloading some operations to the terminal and reducing server-side resource usage. Regardless of distribution, the core pipeline involving keyword and topic extraction, emotion classification, prompt sentence generation, and generative AI response generation remains as described, ensuring that the overall system behavior is consistent and that technical advantages such as improved computational efficiency, reduced communication load, and higher safety and personalization are achieved.

Through these embodiments, the server, the terminal, and the user cooperatively implement the claimed system in a manner that is concrete, technically detailed, and reproducible, enabling a person skilled in the art to implement the invention and to benefit from the improvements in computer-based communication processing.

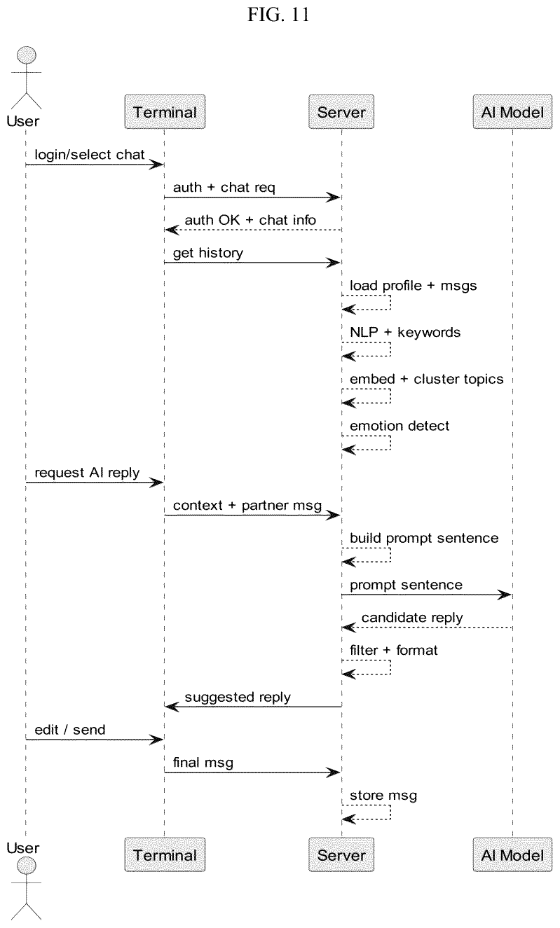

The following describes the processing flow using FIG. 11.
Step 1:

The user operates the terminal to authenticate to the online communication service and select a conversation.

The terminal receives, as input, login credentials and user selection actions (for example, a tap on a conversation thread).

The terminal transmits the login credentials and a conversation selection request to the server.

The server receives, as input, the login credentials and verifies them against authentication data stored in a storage device, and outputs an authentication result and a user identifier.

The server then receives, as input, the conversation selection request including the user identifier, and outputs a confirmation together with conversation metadata to the terminal.
Step 2:

The server acquires, as input, the user identifier and conversation identifier and retrieves user attribute information and past communication information from a storage device.

The server executes data access operations, such as indexed queries on relational tables, to obtain profile fields and a set of historical messages associated with the user.

The server converts database records into an internal data structure, for example, arrays or lists of message objects and a profile object, and outputs these as text data and structured metadata to a natural language processing module.
Step 3:

The server receives, as input, the past communication information in text form and the associated metadata.

The server applies a natural language processing algorithm to perform tokenization and part-of-speech tagging on each message, thereby transforming raw text into sequences of linguistic units annotated with part-of-speech labels.

The server performs data processing operations including counting term occurrences, computing term frequency values, and removing unnecessary terms based on a stop-word list.

The server outputs a keyword set representing high-information terms and phrases as well as an intermediate representation of tokenized messages to be used in subsequent processing.
Step 4:

The server receives, as input, the tokenized messages and the keyword set.

The server uses an embedding model to convert sentences or messages into numerical vector representations, performing matrix multiplications and non-linear activation functions at each network layer.

The server applies a clustering method to the set of vectors and computes, as part of the data operation, distances between vectors, cluster centroids, and cluster assignments, thereby grouping related messages into topic groups.

The server outputs a topic group structure that associates each cluster with representative keywords and labels, and stores this structure as part of the user's context.
Step 5:

The server receives, as input, recent messages from the user and the communication partner, along with the user's keyword set and topic groups.

The server applies an emotion analysis algorithm to the user's recent messages by extracting features such as n-grams, punctuation patterns, and embeddings, and propagating these features through a neural classifier to compute probabilities over emotion labels.

The server determines a user emotional state by selecting the label with the highest probability and associates a confidence score with this state.

The server outputs the user emotional state and may update a temporal profile of emotional trends used in further computations.
Step 6:

The server receives, as input, the keyword set, the topic groups, the user emotional state, the latest message content from the communication partner, and optional user preferences such as desired tone and response length.

The server determines a user personality tendency by performing data operations such as calculating average message length, analyzing pronoun usage, and evaluating sentiment stability from the past communication information.

The server constructs a conversation context object that combines user interests, topic groups, personality tendency, emotional state, and the latest partner message.

The server outputs this conversation context object as structured data for use by a prompt sentence generation module.
Step 7:

The server receives, as input, the conversation context object.

The server selects a prompt template from a set of stored templates by applying decision rules that consider conversation type, emotional state, and topic distribution.

The server performs template processing by inserting specific values for user interests, topic descriptions, personality descriptors, partner message content, and constraints such as desired writing style and response length into placeholder fields.

The server outputs a completed prompt sentence in natural language, for example:
“User profile: enjoys movies (especially sci-fi), likes live rock concerts, and is planning a trip to Kyoto. Partner's message: ‘I love music too! What kind of concerts do you go to?’ Please generate a natural, flirty but polite reply that matches the user's interests.”
Step 8:

The server receives, as input, the prompt sentence and generation parameters such as temperature, maximum token count, and sampling configuration.

The server packages this data into a request object and transmits it to an external generative AI model via a network-based application programming interface using a secure protocol.

The generative AI model performs internal neural network computations and returns, as output, response candidate text and associated metadata such as token usage.

The server receives this response candidate text as input to a post-processing module and outputs it as a raw generated response sequence.
Step 9:

The server receives, as input, the response candidate text.

The server applies a content restriction module that executes pattern matching, rule checking, and, optionally, secondary classification on the text to detect prohibited content.

The server performs data operations including string scanning, regular expression evaluation, and classification score thresholding to identify undesirable segments.

The server modifies or removes offending segments and then applies formatting processing, such as normalizing white space and correcting capitalization, to produce a cleaned and well-formed text.

The server outputs a substitute response message that satisfies safety and formatting requirements.
Step 10:

The server receives, as input, the substitute response message and the destination terminal identifier.

The server transmits the substitute response message to the terminal via a communication protocol, including message identifiers and metadata.

The terminal receives, as input, the substitute response message and updates a user interface element, such as a text field or suggestion area, to display the message as a suggested reply.

The terminal outputs the displayed suggestion to the user and allows the user to edit the text, thereby generating an updated message based on user input actions.
Step 11:

The user reviews, as input, the suggested substitute response message displayed on the terminal.

The user optionally edits the message contents using an input device, creating modified text that reflects personal adjustments.

The terminal receives the edited text and, upon a send command from the user, transmits the final message text back to the server as a new outgoing message in the conversation.

The server receives, as input, the final message text and stores it as part of the past communication information, thereby updating the data available for future analysis and further interactions with the generative AI model and prompt sentence generation process.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In large-scale information distribution environments, such as content delivery platforms and networked information services, a computing device is often required to present personalized content to an end user. Conventional recommender systems typically rely on hand-crafted scoring rules or simple machine learning models that directly map historical usage records to content identifiers. Such conventional systems suffer from several technical shortcomings in terms of computer technology itself.

First, conventional systems generally do not explicitly separate (i) low-level feature extraction from user history data, (ii) inference of a structured user profile, and (iii) generation of a machine-interpretable instruction for a generative model. As a result, processing logic tends to be tightly coupled to specific datasets, making it difficult to reuse models or scale the system to large and diverse content catalogs without substantial reconfiguration of the software and database schemas. This leads to increased processing overhead and inefficient use of processor and memory resources.

Second, conventional systems typically lack a mechanism to leverage a generative artificial intelligence model through a structured prompt sentence that encodes inferred user preferences together with a candidate content set. Without such a prompt structure, a generative model cannot reliably reason about selection criteria and prioritization across many heterogeneous content items. This often causes non-deterministic or semantically inconsistent recommendation results, requiring additional post-processing and repeated inference, thereby increasing processor load, network traffic, and latency.

Third, many existing approaches do not maintain a closed feedback loop that integrates fine-grained usage behavior information, such as user reactions specifically to recommended items, back into the machine learning model and the generative artificial intelligence model in a coordinated fashion. Consequently, models are updated infrequently or in a coarse-grained manner, causing degradation of recommendation accuracy over time, inefficient utilization of storage and bandwidth, and the need for expensive batch retraining that temporarily consumes substantial computational resources.

Fourth, conventional architectures frequently process recommendation reasoning and content explanation generation in multiple disjoint modules, where one module selects items and another module generates natural-language explanations. This fragmentation can cause redundant storage of intermediate data, duplication of logic, and additional data conversion between formats. The redundancy increases processing time and memory usage within the processor and across network interfaces.

Accordingly, there is a need for a computer-implemented system that improves the technical functioning of a server by: (i) structuring user history into machine-learning-friendly features, (ii) inferring a unified user profile, (iii) automatically constructing a prompt sentence that encodes both the user profile and candidate content information for a generative artificial intelligence model, and (iv) feeding back user behavior on recommended items into subsequent inference cycles. Such a system can reduce overall computational overhead, improve consistency and quality of recommendations, and enhance the efficiency of storage and network resources at the level of computer technology, rather than merely implementing a business or presentation logic.

The specific processing by the specific processing unit 290 of the data processing device 12 in Application Example 1 is realized by the following means.

The present invention provides a server comprising a processor and a storage device, the processor being configured to acquire attribute information and history information of a user from the storage device based on identification information that identifies the user, preprocess the acquired history information using an information processing program to generate numerical features and categorical features, execute a machine learning model using the generated features to estimate an attribute profile indicating preferences and interests of the user, construct an input text including the attribute profile and a set of content information, generate a structured prompt sentence based on the input text, input the prompt sentence to a generative artificial intelligence model, analyze response information received from the generative artificial intelligence model to extract recommendation target information from the set of content information based on identifiers included in the response information, generate a recommendation list including justification information corresponding to each piece of the recommendation target information, transmit the recommendation list to a terminal device for visual or auditory presentation to the user, and accumulate, as updated history information, usage behavior information regarding the recommendation target information received from the terminal device in the storage device so that subsequent execution of the machine learning model and the generative artificial intelligence model is performed using the updated history information. This enables an improvement in computer technology by reducing redundant processing and memory transfers through the structured separation of feature extraction, profile inference, prompt generation, and generative inference, by allowing the generative artificial intelligence model to perform natural-language reasoning over a bounded set of candidate contents encoded in the prompt sentence, and by establishing a closed feedback loop in which the server continually refines internal models using fine-grained user behavior, thereby improving the efficiency, scalability, and responsiveness of personalized content recommendation processing at the server.

The term “processor” refers to a hardware or virtual computation unit, such as a central processing unit or a processing core in a virtual machine, that executes instructions of an information processing program to perform data acquisition, analysis, and control of other components in the system.

The term “storage device” refers to a hardware or virtual data storage resource, such as a magnetic storage medium, a solid-state storage medium, or a network-accessible storage medium, that stores attribute information, history information, content information, models, and program code used by the processor.

The term “identification information” refers to data used to uniquely or quasi-uniquely distinguish a user within the system, including but not limited to user identifiers, account identifiers, session identifiers, or device identifiers.

The term “attribute information” refers to data representing static or relatively slowly changing characteristics of a user, such as demographic attributes, declared preferences, or configuration parameters associated with the user.

The term “history information” refers to data representing past behavior of a user, including but not limited to viewing records, search records, selection records, interaction events, and other usage logs collected over time.

The term “information processing program” refers to executable instructions, including application logic, libraries, or scripts, that cause the processor to perform operations such as data acquisition, preprocessing, transformation, and communication with external components.

The term “numerical features” refers to numerical values derived from history information or attribute information, such as counts, frequencies, normalized scores, or embedded vectors, that are suitable as input to a machine learning model.

The term “categorical features” refers to discrete or symbolic values derived from history information or attribute information, such as class labels, category identifiers, or encoded textual values, that are suitable as input to a machine learning model.

The term “machine learning model” refers to a parameterized computational model, such as a neural network, a regression model, or a classification model, that has been trained on data to map input features to output values including profiles, scores, or probability distributions.

The term “attribute profile” refers to a structured representation of estimated preferences, interests, or tendencies of a user produced by the machine learning model based on attribute information and history information.

The term “content information” refers to data describing items that can be recommended to a user, including identifiers, titles, categories, metadata, and other attributes associated with digital content or services.

The term “set of content information” refers to a collection of content information entries that serve as candidate items from which recommendation target information is to be selected.

The term “input text” refers to a text string or structured textual representation generated by the processor, which includes at least part of the attribute profile and the set of content information and is used to form a prompt sentence.

The term “prompt sentence” refers to a text sequence or structured prompt constructed from the input text, which instructs a generative artificial intelligence model to perform a specific task, such as selecting or ranking content items, based on encoded user profile information and candidate content information.

The term “generative artificial intelligence model” refers to a computational model capable of generating text or structured data outputs in response to a prompt sentence, using techniques such as neural sequence modeling or probabilistic generation.

The term “response information” refers to output data generated by the generative artificial intelligence model in response to the prompt sentence, including at least identifiers of selected content items and, optionally, natural-language explanations or reasoning information.

The term “identifier” refers to a data element, such as a string or numeric value, that uniquely or quasi-uniquely indicates a particular content item or entity within the set of content information.

The term “recommendation target information” refers to content information entries that are selected, based on response information from the generative artificial intelligence model, as items to be recommended to the user.

The term “recommendation list” refers to a structured aggregation of recommendation target information entries, including associated justification information, prepared for transmission to and presentation by a terminal device.

The term “justification information” refers to data, typically in textual form, describing a reason or rationale for why a particular recommendation target information entry is selected for a user.

The term “terminal device” refers to an end-user computing device, such as a mobile terminal, a portable information processing device, or a general-purpose computing device, that receives the recommendation list and presents information to the user.

The term “usage behavior information” refers to data representing user actions in response to recommended items, including but not limited to selection events, playback events, viewing durations, or interaction patterns, which are used to update history information.

The term “probability distribution” refers to a set of numerical values output by the machine learning model that indicate relative likelihoods or degrees of preference of the user for different fields, categories, or attributes.

The term “interest vector” refers to a numerical vector representation output by the machine learning model that encodes latent aspects of the user's interests in a multi-dimensional space.

The term “profile information of the user” refers to data provided to the generative artificial intelligence model that includes the attribute profile, the probability distribution of preferred fields, and the interest vector.

The term “selection criteria” refers to conditions, rules, or patterns inferred or applied by the generative artificial intelligence model to choose recommendation target information from the set of content information.

The term “prioritization” refers to an ordering or ranking assigned to candidate content items based on their estimated suitability or relevance to the user.

The term “natural language reasoning” refers to processing by the generative artificial intelligence model in which relationships, explanations, and decisions are inferred and represented using human-language expressions based on the prompt sentence and internal model parameters.

In one embodiment, a server cooperates with one or more terminals operated by a user in order to generate and present personalized recommendations using a generative AI model. The server includes at least one processor, a memory, a non-volatile storage device, and a network interface. The storage device stores attribute information and history information of the user, content information for multiple candidate contents, a machine learning model, and a generative AI model access program. The processor executes an information processing program stored in the memory to perform the functions described below.

The server uses a general-purpose computing platform, for example, a server computer equipped with one or more central processing units and, optionally, one or more graphics processing units. The server operates under a general-purpose operating system and uses a database management system to store attribute information, history information, and content information. The server uses an application runtime environment, for example, a programming language environment with numerical computation libraries and a machine learning framework such as a tensor-based computation framework. The server accesses the generative AI model through an external service interface or an internal inference engine that supports text generation.

The terminal uses a hardware configuration such as a mobile communication device, a portable information processing device, or a general-purpose computing device with a display, an audio output unit, an input unit, a communication module, and a local storage unit. The terminal executes a client application that communicates with the server via a communication network, for example, the Internet or a cellular network.

The user operates the terminal to access a recommendation function. The user may provide explicit attribute information, such as age range, language preference, or content categories of interest, via user interface elements of the terminal. The user also generates history information by consuming content, performing searches, and interacting with recommended items on the terminal. The terminal transmits such interactions to the server, and the server accumulates the data as history information in the storage device.

The server stores history information in a structured form suitable for efficient retrieval and processing. The server uses tables or collections for viewing history, search history, and interaction events, each row including a user identifier, a content identifier or query string, a timestamp, and additional attributes such as duration, completion rate, or interaction type. The server organizes content information in one or more tables or collections containing content identifiers, titles, categories, tags, regions, and availability flags.

The server performs feature extraction from history information in a non-conventional, model-oriented manner. The server converts history information into numerical features and categorical features that are specifically shaped as input tensors for the machine learning model. The server, for example, computes normalized viewing time per category, counts of searches containing specific keywords, distributions of access times over a day or a week, and recency-weighted frequencies of content accesses. The server encodes categorical attributes such as categories, device types, and regions using one-hot or embedding-based encodings. The server aggregates these features into well-defined feature vectors with fixed dimensions. By structuring the data in this way, the server reduces the need for manual rule tuning and enables more efficient use of vectorized computation units in the processor and the graphics processing unit.

The server executes a machine learning model to transform the feature vectors into an attribute profile of the user. In one embodiment, the machine learning model has a neural network architecture including an input layer corresponding to the feature vector, one or more fully connected hidden layers with non-linear activation functions, and an output layer that produces, in parallel, a probability distribution over content fields and an interest vector. The interest vector is represented in a latent space with a predetermined number of dimensions. The server may use other architectures, such as a recurrent neural network or a transformer-based encoder, depending on the type of history data and desired temporal modeling.

The server trains the machine learning model offline using a training dataset that includes history information from multiple users and ground-truth labels such as actual user selections or satisfaction scores. During training, the server initializes model parameters, defines a loss function that combines a classification loss term for field prediction and a regression or metric-learning loss term for interest vector alignment, and performs weight updates using a gradient-based optimization algorithm such as stochastic gradient descent or an adaptive variant. The server may apply regularization techniques such as dropout, weight decay, or early stopping. The server may also apply data augmentation, for example by randomly masking a portion of history events or perturbing time intervals to improve model robustness. The server then deploys the trained model for inference in the online system.

The server executes the machine learning model for inference when new recommendations are requested. The server loads the model into memory and performs forward propagation of the feature vector through the network. Because the feature vector is structured for dense matrix operations, the server can utilize hardware acceleration, such as vector instruction sets or graphics processing units, which leads to reduced processing time and lower energy consumption compared to rule-based systems that require complex branching logic.

The server constructs an attribute profile from the outputs of the machine learning model. The attribute profile includes, for example, a list of preferred fields derived from the probability distribution, a set of avoided fields inferred from low-probability regions, and the interest vector. The attribute profile also may include derived attributes such as a preferred content length category or a viewing time pattern, which the server computes using deterministic post-processing rules applied to the model outputs.

The server selects a set of content information as candidate items. In one embodiment, the server queries the database to retrieve content entries whose categories align with the preferred fields, whose region attributes match the region of the user, and whose availability flags indicate that the items are currently accessible. The server may further restrict the set based on recency or popularity to limit the size of the candidate set and reduce the computational load in subsequent processing. The server arranges the candidate items in a data structure such as an array or list of objects, each containing at least an identifier, a title, and a set of tags.

The server constructs a prompt sentence to be input to the generative AI model. The server converts the attribute profile and the candidate content information into a textual representation. The server may format the prompt sentence as a sequence of lines, where the first part describes the role of the generative AI model, the second part describes the user profile, and the third part lists candidate contents. For example, the server may generate a prompt sentence such as:
“You are a recommendation engine.
User profile:
Favorite genres: science fiction, action
Disliked genres: romance
Keywords: space, time travel, future
Preferred length: feature film

Candidate contents:
1. Title: Galactic Frontier, Genre: science fiction, Tags: space, exploration, Year: 2026
2. Title: Time Loop City, Genre: science fiction, Tags: time travel, mystery, Year: 2025
Task: From the candidate contents, select the 10 best items for this user and provide one or two sentences explaining why each item matches the user's interests. Output the selected items and their reasons in a structured but plain-text format.”

The server configures the prompt sentence to include explicit instructions about selection criteria and output structure so that the generative AI model performs a constrained reasoning process rather than arbitrary text generation. By constraining the candidate set and explicitly encoding the attribute profile, the server reduces the search space that the generative AI model needs to explore and improves the reproducibility and consistency of recommendations.

The server uses a generative AI model that has a neural network architecture suitable for sequence generation, for example, a transformer-based language model. The generative AI model is trained on large-scale text data to predict the next token based on previous tokens. In one embodiment, the server accesses such a generative AI model through an application programming interface, providing the prompt sentence and receiving the generated text as response information. The server may control parameters such as maximum output length, randomness level, and sampling strategy to balance creativity and determinism.

The server analyzes the response information generated by the generative AI model. The response information includes, for each recommended item, at least a reference to the candidate content and an explanatory sentence. The server parses the response to identify content identifiers or titles. The server then cross-references those identifiers with the candidate set to avoid spurious outputs not contained in the candidate set. The server constructs a recommendation list by aligning each identified candidate content with its corresponding explanation, which becomes justification information. The server may discard or correct incomplete entries and may impose a limit on the number of recommendations. The server transmits the recommendation list to the terminal via a network interface. The server formats the recommendation list as a structured message and sends it over a secure connection. The server may attach additional metadata such as ranking scores, thumbnail locations, or playback URLs that the terminal can use to render the recommendations.

The terminal receives the recommendation list and processes it in the client application. The terminal parses the message, extracts content identifiers, titles, justification information, and display-related metadata, and constructs user interface elements. The terminal displays recommended items in a list or grid, along with explanations such as “This movie focuses on space exploration, which matches your frequent searches about space.” The terminal may also read out the explanations using a text-to-speech engine, providing an auditory interface. The user reviews the recommendations and selects content items for consumption. The terminal records the user's interactions, including selection events, playback start and stop events, skipping events, and completion rates. The terminal transmits such usage behavior information back to the server as new history information. The server stores the usage behavior information in the history tables and, over time, updates the training dataset for the machine learning model. The server may periodically retrain the model or perform incremental updates so that the model parameters reflect recent usage patterns.

The server, by structuring the processing in this manner, improves the technical operation of the recommendation system. The separation of feature extraction, profile inference, prompt generation, and generative reasoning allows each component to be individually optimized for computational efficiency. For example, the feature extraction module uses vectorized operations that minimize memory access overhead, the machine learning model uses batch inference to exploit parallelism, and the prompt generation module compresses user profile and candidate content information into a compact textual representation that reduces the amount of data transmitted to the generative AI model. Compared to a purely rule-based system that requires complex conditional branches and extensive manual tuning, this architecture reduces CPU cycles and lowers latency.

The server, by limiting the generative AI model's reasoning to a predefined candidate set and explicitly encoding user profile information, reduces the risk of irrelevant or incoherent recommendations and reduces the number of times the generative AI model must be invoked. This reduction in calls decreases network traffic and shortens response time. In addition, by incorporating justification information directly produced by the generative AI model, the server avoids a separate explanation-generation module, reducing memory consumption and avoiding redundant processing.

The server, by maintaining a closed feedback loop that feeds fine-grained usage behavior information into subsequent model executions, improves prediction accuracy and stability without requiring expensive full retraining sessions at every update. The server can use incremental training or periodic batch updates with a limited portion of the most recent data, which provides a favorable trade-off between computational cost and recommendation quality. This feedback mechanism is different from manual rule adjustment and enables the system to adapt to changing user behavior while maintaining efficient use of computational resources.

In another embodiment, the server uses an alternative neural network architecture for the machine learning model. For example, the server may use a sequence model that explicitly models the order of history events. The server may represent history information as a sequence of content identifiers or event embeddings and use a transformer-encoder with attention mechanisms to compute a sequence representation. The server then uses a pooling layer to obtain the interest vector. This architecture may improve sensitivity to temporal patterns in usage behavior and further increase recommendation precision, while still benefiting from the structured prompt approach to reduce generative computation.

In another embodiment, the server employs a hybrid approach with a rule-based pre-filter that quickly eliminates obviously irrelevant candidates, such as content outside the user's language or region, before applying the machine learning model and generative AI processing. This reduces the size of the candidate set passed into the prompt sentence, which leads to shorter prompts, faster generative reasoning, and lower bandwidth usage between the server and the generative AI model interface.

In yet another embodiment, the server deploys caching mechanisms for attribute profiles or intermediate feature representations. When the user requests recommendations repeatedly within a short period, the server reuses cached profiles and only updates features corresponding to the latest history events. This reuse of intermediate results reduces redundant computation and improves responsiveness, which is particularly important in high-traffic scenarios.

The described embodiments focus on the technical implementation of a recommendation system that uses a generative AI model through a structured prompt sentence and a machine learning-based profile inference mechanism. The server, by integrating these components with specific data structures, neural network architectures, and feedback updating mechanisms, improves computer performance in terms of processing speed, resource usage, and output quality. The system does not merely automate human judgment but employs computational structures and flows that a human operator cannot practically realize at scale, thereby achieving a concrete improvement in computer technology.

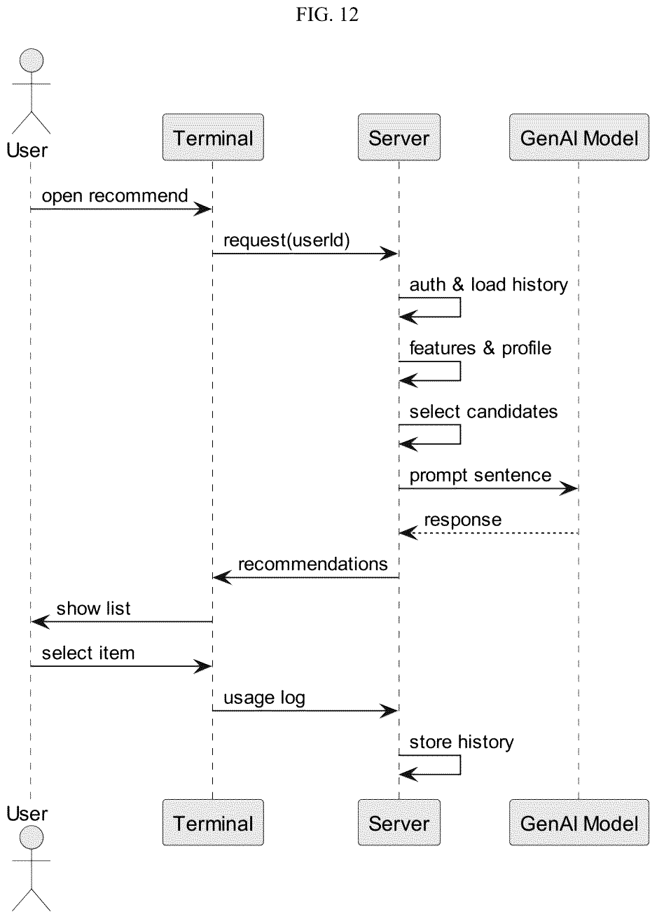

The following describes the processing flow using FIG. 12.
Step 1:

The terminal transmits a recommendation request to the server.

The terminal uses a client application to detect that the user has opened a recommendation screen or pressed a recommendation button. As input, the terminal uses a user identifier stored in local storage, device information, and language settings. The terminal constructs a request message including the user identifier and environment information, and sends the message via a secure communication channel to an application programming interface of the server. As output, the terminal provides an HTTP or similar network request that initiates recommendation processing on the server.
Step 2:

The server authenticates the request and identifies the user.

The server receives the network request as input through a network interface and terminates encryption at a communication layer. The server checks an authentication token or session identifier contained in the request header and compares it with authentication data stored in a storage device. The server validates that the user identifier in the request body matches an authenticated account. As data processing, the server parses the request, verifies integrity, and records a log entry including timestamp, user identifier, and endpoint type. As output, the server obtains a verified user identifier and a processing context to be used in subsequent steps.
Step 3:

The server retrieves attribute information and history information of the user.

The server uses the verified user identifier as input to a database query module. The server sends structured queries to a database management system to read attribute records and history records such as viewing history and search history. The server filters history entries by the user identifier and by a time range to limit the amount of data. The server converts the returned rows into in-memory objects or structured records. As output, the server obtains a collection of attribute information and raw history information associated with the user.
Step 4:

The server preprocesses the history information into numerical features and categorical features.

The server uses the raw history information as input to a feature extraction module executed by the processor. The server aggregates counts of accessed content categories, computes normalized viewing times, and calculates recency weights using mathematical operations such as summation, division, and exponential decay. The server tokenizes search query strings into words, removes stopwords, and counts keyword frequencies. The server encodes categorical values, such as content category or device type, into vector representations using one-hot encoding or embedding indices. As data processing, the server transforms irregular and sparse logs into fixed-length feature vectors by applying aggregation, normalization, and encoding operations. As output, the server produces numerical features and categorical features that are suitable as input for a machine learning model.
Step 5:

The server executes a machine learning model to infer an attribute profile of the user.

The server uses the numerical features and categorical features as input to a neural network model loaded in memory. The server performs matrix multiplications and non-linear activation operations layer by layer, propagating the input features through the network architecture. The server computes a probability distribution over content fields and an interest vector in a latent space. The server may also compute auxiliary scores such as preferred content length or time-of-day preference. As data processing, the server uses learned weights and biases stored in the model to transform the input features into high-level preference representations. As output, the server obtains an attribute profile containing preferred fields, disfavored fields, and the interest vector.
Step 6:

The server selects candidate content information based on the attribute profile.

The server uses the attribute profile as input to a content selection module. The server issues database queries or search requests using the preferred fields, region data, and availability flags as filter conditions. The server retrieves content records that match these conditions and may further apply ranking heuristics such as favoring recent or popular items. The server converts each record into a structured content information entry containing at least an identifier, a title, a category, and tags. As data processing, the server filters and arranges data from a large content catalog into a bounded candidate set. As output, the server produces a set of candidate content information entries that are tailored to the inferred preferences of the user.
Step 7:

The server constructs a prompt sentence for a generative AI model.

The server uses the attribute profile and the candidate content information as input to a prompt generation module. The server formats the attribute profile as descriptive text, for example listing favorite categories and representative keywords, and formats each candidate content entry with its title, category, tags, and relevant metadata. The server concatenates these textual elements with explicit instructions that define the task to be performed by the generative AI model. As data processing, the server transforms structured data into a linear text sequence that encodes both user preferences and candidate options. As output, the server generates a prompt sentence such as:
“You are a recommendation engine.
User profile:
Favorite genres: science fiction, action
Disliked genres: romance
Keywords: space, time travel, future
Preferred length: feature film
Candidate contents:
1. Title: Galactic Frontier, Genre: science fiction, Tags: space, exploration, Year: 2026
2. Title: Time Loop City, Genre: science fiction, Tags: time travel, mystery, Year: 2025
Task: From the candidate contents, select the best items for this user and provide one or two sentences explaining why each item matches the user's interests. Output the selected items and their reasons in a structured but plain-text format.”
Step 8:

The server transmits the prompt sentence to a generative AI model and receives response information.

The server uses the prompt sentence as input to a generative AI model interface. The server packages the prompt as a request and sends it via a communication protocol to a model inference endpoint, specifying parameters such as maximum tokens and randomness level. The generative AI model processes the prompt and generates a text response. The server receives the response text and stores it temporarily in memory. As data processing, the server handles serialization and deserialization of the prompt and response and manages communication latency and error handling. As output, the server obtains response information that contains descriptions and selection indications for recommended items.
Step 9:

The server parses the response information and constructs a recommendation list.

The server uses the response information as input to a parsing module. The server analyzes the text to detect references to candidate content items, for example by matching titles or identifiers mentioned in the response with those in the candidate set. The server extracts explanation segments that describe reasons for selecting each candidate. The server verifies that each referenced item exists in the candidate set and discards any references to unknown items. As data processing, the server segments the text, performs string matching or pattern recognition, and binds explanations to specific content identifiers. As output, the server generates a recommendation list that includes, for each recommendation target, an identifier, a title, and justification information.
Step 10:

The server transmits the recommendation list to the terminal.

The server uses the recommendation list as input to a response generation module. The server adds display-related metadata such as positions, ranking values, and thumbnail references if necessary. The server converts the recommendation list into a structured response format and sends it through the network interface to the terminal over a secure channel. As data processing, the server serializes internal structures into a network-transmittable representation and schedules transmission. As output, the server provides a response message that the terminal can interpret to render personalized recommendations.
Step 11:

The terminal receives the recommendation list and presents recommended contents to the user.

The terminal uses the response message from the server as input. The terminal parses the message, extracts content identifiers, titles, categories, and justification information, and constructs visual user interface components such as cards or list entries. The terminal requests associated images or media resources if needed and arranges them on the display according to the ranking order. As data processing, the terminal converts received data into graphical elements and maps justification text onto labels or description fields. As output, the terminal presents the recommendation targets and the associated explanations to the user via the display and, optionally, via an audio output unit.
Step 12:

The user interacts with the recommended contents.

The user uses the displayed interface as input and performs actions such as scrolling through the list, selecting a recommended item, starting playback, or dismissing items. The user's taps, clicks, and playback controls generate events inside the client application on the terminal. As data processing, the human actions are converted by the terminal into structured event records with associated timestamps and content identifiers. As output, the user provides implicit and explicit feedback about preference through these interaction events.

Step 13:

The terminal records usage behavior information and sends it to the server.

The terminal uses the interaction events generated by the user as input to a logging module. The terminal aggregates events such as selection, play start, play stop, and completion into usage behavior records. The terminal may buffer multiple events and compress them to reduce communication overhead. The terminal transmits the usage behavior information to the server via the network interface. As data processing, the terminal timestamps events, associates them with the user identifier, and structures them into compact messages. As output, the terminal provides updated history-related data to the server.
Step 14:

The server stores the usage behavior information and updates history information.

The server uses the received usage behavior information as input. The server writes each record into appropriate history tables or collections in the storage device, linking the records to the corresponding user identifier and content identifier. The server may also update aggregated counters or summary tables that are used to accelerate subsequent feature extraction. As data processing, the server executes insert and update operations, maintains indexes, and may recalculate derived statistics. As output, the server maintains an updated and consistent set of history information that reflects the user's reactions to recommended items and is ready to be used in future iterations of feature extraction and model inference.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional automated reply systems that utilize natural language processing and machine learning typically generate responses based only on the latest incoming message, or on shallow user profile attributes. Such systems often treat the generative AI model as a black-box text generator with a fixed, generic prompt, without dynamically conditioning the model on rich, structured context derived from the user's long-term communication history or actual user behavior regarding which suggested replies are accepted or edited. As a result, these systems frequently produce responses that are contextually inappropriate, inconsistent with the user's preferences and conversational style, or redundant with past conversations. Moreover, because these conventional systems rely on ad-hoc application logic to prepare input for the generative AI model, they suffer from inefficiencies and scalability issues when the amount of communication data and user history becomes large.

In addition, in many existing architectures, the processing pipeline between receiving a message, analyzing its content, retrieving relevant user characteristics, constructing a prompt for the generative AI model, and post-processing the generated response is not explicitly integrated. Instead, separate, loosely coupled modules handle these steps with minimal feedback loops. This leads to increased latency, higher computational overhead, and difficulty in maintaining consistency across models, prompts, and stored user data. Further, such systems typically do not leverage user feedback—particularly whether a suggested reply was accepted as-is or edited before sending—as a first-class signal to refine future response generation and to update user characteristics in a structured manner.

From a computer technology perspective, these limitations result in suboptimal utilization of computing resources and memory structures. Unstructured handling of user history forces repeated, redundant analysis of past data, increasing processor load and network traffic between storage layers and application logic. Static or minimally parameterized prompts prevent the generative AI model from effectively using available information, lowering the quality of generated responses and requiring additional corrective logic on the server side. The absence of a well-defined mechanism for embedding structured user and conversation context into prompt sentences leads to inefficient data paths and reduces the system's ability to adapt over time based on observed user actions.

Accordingly, there is a need for an improved computer-implemented system and server-side processing architecture that (i) structurally couples message analysis, user characteristic retrieval, and dynamic prompt generation, (ii) embeds structured context data into prompt sentences to condition the generative AI model, (iii) performs systematic post-processing and feedback logging for generated responses, and (iv) updates user characteristics based on actual user interactions with candidate replies. Such a system should improve the efficiency and effectiveness of computer-based communication handling, reduce redundant processing, and enhance the adaptability and personalization of automated responses, thereby improving the underlying computer technology that supports large-scale conversational services.

The specific processing by the specific processing unit 290 of the data processing device 12 in Example 2 is realized by the following means.

The present invention provides a server comprising a processor and a memory storing instructions that, when executed by the processor, cause the processor to receive communication information from a user terminal together with user identification information and store the communication information in association with the user identification information, to analyze natural language text included in the communication information by executing natural language processing and semantic analysis using a generative AI model to extract intent information, topic information, and keyword information, to acquire preference information and past communication history information associated with the user identification information from an information storage device and integrate the acquired information as user characteristic information, to generate, based on the intent information, the topic information, the keyword information, and the user characteristic information, a prompt sentence for input to the generative AI model, the prompt sentence including response generation conditions and embedded structured data derived from at least part of the communication information and the user characteristic information, to input the prompt sentence to the generative AI model to cause the generative AI model to generate response text, to perform post-processing on the generated response text including at least inappropriate expression detection, length adjustment, and format normalization, to transmit the post-processed response text to the user terminal as a candidate reply, and to register, as communication history information, final response text that is transmitted after confirmation or editing by a user and to update the user characteristic information based on acceptance or rejection of the candidate reply and on editing content applied to the candidate reply. This enables an integrated, feedback-aware processing pipeline in which the server structurally links message analysis, dynamic prompt construction with embedded structured context, and adaptive updating of user characteristics, thereby improving the efficiency and accuracy of computer-implemented response generation, reducing redundant computation across communication sessions, and enhancing the technical performance of communication handling systems that utilize generative AI models.

The term “system” refers to an arrangement of one or more computing devices, including at least one processor and one or more storage devices, that cooperate to execute the processing described in the claims.

The term “processor” refers to a hardware processing unit, such as a central processing unit or a graphics processing unit, or a combination thereof, that executes instructions to perform arithmetic operations, logical operations, control operations, and data transfer operations.

The term “memory” refers to a hardware storage device, such as a semiconductor memory, a magnetic storage device, or an optical storage device, that stores instructions and data to be used by the processor.

The term “information storage device” refers to a hardware storage resource, including but not limited to a database system, a file system, or a key-value store, that persistently stores communication information, user identification information, user characteristic information, and related metadata.

The term “user terminal” refers to an electronic device operated by a user, such as a smartphone, a tablet, a personal computer, or another communication device, that transmits and receives messages and interacts with the system over a communication network.

The term “communication information” refers to data representing one or more communication events, including at least natural language text of messages, and optionally including associated metadata such as timestamps, conversation identifiers, and counterpart identifiers.

The term “user identification information” refers to information that enables the system to distinguish one user from another, such as a user identifier, an account identifier, or another unique or pseudo-unique identifier.

The term “natural language text” refers to character strings expressing human language, such as sentences and phrases written in a natural language including, but not limited to, English, Japanese, or other spoken languages.

The term “natural language processing” refers to a set of computational techniques for analyzing natural language text, including but not limited to tokenization, part-of-speech tagging, parsing, entity recognition, intent detection, and semantic interpretation.

The term “semantic analysis” refers to processing that interprets the meaning or context of natural language text, including extracting relationships, determining user intent, identifying topics, and inferring relevant concepts.

The term “generative AI model” refers to a machine-learned model that receives input data, including at least a prompt sentence, and generates output data, such as natural language text, based on learned statistical patterns, including but not limited to large language models.

The term “intent information” refers to data representing a purpose or goal of a message, such as requesting information, making a suggestion, asking a question, or expressing a preference, as inferred from the communication information.

The term “topic information” refers to data representing a subject or theme of a message, such as movies, travel, work, or hobbies, as derived from the content of the communication information.

The term “keyword information” refers to data identifying one or more important words or phrases extracted from the communication information that are relevant to understanding the message or generating a response.

The term “preference information” refers to data that represents a user's likes, dislikes, interests, tendencies, or other stable or semi-stable behavioral attributes, derived from explicit user input or from analysis of communication history.

The term “past communication history information” refers to stored records of previous communications associated with a user, including message content, timestamps, and interaction outcomes, accumulated over time.

The term “user characteristic information” refers to information that integrates preference information and past communication history information, and optionally other user-related attributes, into a representation used by the processor to condition analysis and response generation.

The term “prompt sentence” refers to a text or structured representation provided as input to a generative AI model, the text or representation including instructions, constraints, context information, and optionally structured data, to control or condition the behavior of the generative AI model.

The term “response generation conditions” refers to constraints or instructions included in the prompt sentence, such as target language, tone, style, length, content limitations, and other parameters that influence the generated response text.

The term “structured data” refers to data organized according to a predefined schema or format, such as key-value pairs, tables, or hierarchical data structures, that can be programmatically embedded into a prompt sentence or processed by the generative AI model.

The term “response text” refers to natural language text generated by the generative AI model as a reply or candidate reply to the communication information received from a communication partner.

The term “post-processing” refers to processing applied to response text after generation by the generative AI model, including but not limited to inappropriate expression detection, length adjustment, format normalization, and other modification or filtering operations.

The term “inappropriate expression detection” refers to processing that determines whether response text includes content that is offensive, abusive, unsafe, or otherwise disallowed based on predefined rules, policies, or models.

The term “length adjustment” refers to processing that modifies the length of response text, such as truncating, summarizing, or expanding the text to conform to a desired character count or number of sentences.

The term “format normalization” refers to processing that adjusts the representation of response text, such as normalizing character types, punctuation, spacing, or capitalization, to satisfy formatting rules.

The term “candidate reply” refers to response text that is provided by the system to a user as a suggested message, prior to final transmission to a communication partner.

The term “final response text” refers to text that is ultimately transmitted to a communication partner, the text being based on the candidate reply and optionally modified through user confirmation, selection, or editing.

The term “editing content” refers to modifications made by a user to a candidate reply, including additions, deletions, and substitutions of words or phrases, before the reply is sent as final response text.

The term “communication service for mediating interpersonal encounters” refers to a service that enables users to discover, match, and exchange messages with other users, including but not limited to services used for social networking, dating, or friendship.

The term “matched communication partner” refers to another user who has been associated with a user by the communication service according to one or more matching criteria, and with whom the user can exchange messages.

The term “feedback-aware processing pipeline” refers to a sequence of processing steps in which data derived from user behavior, including acceptance, rejection, and editing of candidate replies, is recorded and utilized to update user characteristic information and influence subsequent response generation.

In one embodiment, a server cooperates with one or more terminals operated by users to implement the claimed system. The server includes at least one processor, such as a multi-core central processing unit and, optionally, one or more graphics processing units, and a memory including a non-transitory storage medium. The memory stores an operating system, a web server program, an application server program, a database management system, and a set of application modules that perform the functions described below. For example, the server executes a web server component implemented using a generic HTTP server, an application layer implemented using a general-purpose application framework, and a database layer implemented using a relational database management system and, optionally, a non-relational storage system.

The terminal operates as a communication device and may be implemented as a smartphone, tablet, or personal computer running a client-side application. The terminal includes a processor, a memory, a display, a network interface, and an input device such as a touch panel or keyboard. The terminal executes an application that provides a message user interface, communicates with the server via a network using secure transport protocols, and presents candidate replies generated by the server to a user.

The server stores communication information, user identification information, user characteristic information, and model-related metadata in one or more storage structures. In one embodiment, the server uses a relational database to store communication information and user identification information in tables having fields such as user identifier, counterpart identifier, conversation identifier, message text, and timestamp. The server uses a document-oriented storage or a key-value store to store user characteristic information in a structured format such as hierarchical key-value pairs, where preference information and communication history summaries are kept.

The server executes a natural language processing module that operates on natural language text contained in communication information. In one embodiment, the server uses a tokenizer that converts a character sequence into token identifiers based on a predefined vocabulary, a part-of-speech tagger implemented by a neural sequence labeling model, and a semantic classifier that identifies intent information and topic information. The server represents each message as a feature vector that includes token embeddings, positional encodings, and additional features such as message length and punctuation statistics. The server thereby transforms raw message text into intermediate numerical representations stored in memory buffers.

The server uses a generative AI model that has a neural network architecture such as a transformer-based sequence-to-sequence network. In one implementation, the generative AI model includes a plurality of attention layers, feed-forward layers, layer normalization units, and residual connections. The server stores model parameters, including weight matrices for attention heads, projection layers, and feed-forward layers, in a model storage region of the memory. The server loads these parameters into GPU or CPU memory when performing inference. The generative AI model receives as input an encoded prompt sentence that is converted into token identifiers and embedding vectors. The generative AI model outputs a sequence of token probability distributions, from which the server samples or selects token identifiers to form response text.

The server configures the generative AI model through a training process executed offline prior to deployment. In one embodiment, the server trains the model using supervised learning on a corpus of conversation data. The server defines a loss function such as cross-entropy between predicted token distributions and ground truth tokens. The server performs gradient-based optimization, updating model parameters using an optimizer such as stochastic gradient descent with momentum or an adaptive learning rate method. The server optionally applies regularization techniques such as dropout and weight decay. The server may also apply data augmentation methods, for example rephrasing messages through paraphrase models or back-translation to increase robustness. As a result, the generative AI model learns to map prompt sentences and embedded context into contextually coherent response text.

The server constructs user characteristic information by aggregating preference information and past communication history information. The server analyzes stored messages for each user to compute statistics such as frequency of certain topics, typical message length, common lexical expressions, and time-of-day activity patterns. The server stores these derived values as structured data, for example, as keys representing topics mapped to weights indicating the user's interest level. The server may include a separate embedding vector that represents the user's communication style, computed using an encoder neural network that processes a sample of the user's past outgoing messages. The server then updates this user characteristic information over time when new final response text is stored, using update rules such as incremental averaging or exponential moving averages. By maintaining structured and incrementally updated user characteristic information, the server reduces the need to repeatedly reanalyze the entire communication history, thereby improving computational efficiency.

The server generates a prompt sentence for the generative AI model by programmatically combining the latest communication information, the extracted intent information, the topic information, the keyword information, and the user characteristic information. In one embodiment, the server builds the prompt sentence as a concatenation of instruction segments and context segments, following a predetermined template. For example, the server may generate a prompt sentence such as:
“You are an assistant that writes chat replies on behalf of the user in a communication service.
User's language: Japanese.
User's preferences: likes science fiction movies and tends to use a casual tone.
Conversation partner's latest message: ‘Any recommendations for movies you've seen recently?’
Detected intent: ask_recommendation
Detected topic: movies
Task: Considering the user's preferences and speaking style, generate a short, natural reply in Japanese that recommends one or two movies. Keep it within two sentences and make it sound like a human chat message.”

The server embeds structured data into the prompt sentence by converting key-value pairs from the user characteristic information into textual descriptions appended to the instruction segment. For example, when the server holds a user characteristic indicating a high weight for a science fiction topic, the server includes a corresponding text portion in the prompt sentence indicating that the user strongly prefers science fiction films. Because the server encodes structured data into the prompt sentence deterministically based on stored user characteristic information, the generative AI model is explicitly and consistently conditioned on the same data representation, improving the stability and repeatability of generated responses.

The server performs post-processing on response text emitted by the generative AI model. In one embodiment, the server executes a content filter implemented by a classification model that receives the response text as tokenized input and outputs a label indicating whether the text contains inappropriate expressions. The server may use a smaller neural network or a rule-based engine with pattern matching for this purpose. When the classification model detects an inappropriate expression, the server either masks or replaces specific phrases using a dictionary or regenerates portions of the text with a modified prompt sentence instructing the model to avoid such content.

The server adjusts the length of response text by computing the number of tokens or characters in the text and enforcing limits defined in system configuration. When the text exceeds a predetermined threshold, the server applies a truncation algorithm that ensures grammatical completeness, such as truncation at sentence boundaries detected by a sentence segmentation module. The server also performs format normalization by converting character types, resolving inconsistent whitespace, and standardizing punctuation according to locale rules stored in configuration files.

The server transmits the post-processed response text to the terminal over a network using a transport protocol such as HTTP over a secure channel. The terminal receives the response text and displays it in a graphical user interface as a candidate reply associated with the current conversation. The user can select the candidate reply for immediate use, modify the text through the terminal's input interface, or discard the suggestion. When the user edits the candidate reply, the terminal calculates the edit distance between the suggested text and the final response text, and transmits information indicating the edit operations to the server, along with the final response text.

The server updates user characteristic information based on acceptance or rejection of candidate replies and on editing content. In one embodiment, when the user sends the response text without modification, the server increases a confidence score for the current combination of user characteristic information and prompt sentence structure, indicating that this configuration is appropriate for similar future messages. When the user significantly edits the candidate reply, the server identifies which portions of the text have been changed and infers adjustments to style or content preferences, such as a preference for shorter messages or avoidance of certain expressions. The server then modifies the corresponding weights or parameters in the user characteristic information. This feedback mechanism enables the server to adjust internal representations without requiring explicit user configuration, improving both personalization and computational efficiency over time.

The server thereby implements an integrated and feedback-aware processing pipeline. Because the server maintains structured user characteristic information and embeds it into prompt sentences, the server reduces redundant analysis of past data and improves the alignment between the generative AI model's output and user-specific requirements. The use of explicit data structures for intent information, topic information, keyword information, and user characteristic information allows the processor to perform targeted retrieval and update operations, which reduces the number of database queries and the volume of data that must be loaded into main memory during each interaction. As a consequence, the system improves processing speed and reduces communication load between application logic and storage subsystems.

The server differs from human manual processing and from simple automation by enforcing a non-conventional, multi-stage algorithm that is optimized for machine execution. The server does not merely replace a human writing replies but restructures the processing in a way that distributes tasks between specialized modules: a natural language analyzer, a user characteristic manager, a prompt generator, a generative AI inference engine, and a post-processing filter. Each module operates with explicitly defined data structures and inter-module interfaces, enabling the server to perform complex context integration and adaptation at a speed and scale that are unattainable by human operators.

In another embodiment, the server uses alternative generative AI models, such as a recurrent neural network-based language model or a hybrid model combining convolutional layers and attention mechanisms. The server may also employ different optimization strategies during training, such as curriculum learning where the server first trains the model on simple examples and gradually increases complexity, or reinforcement learning where the server adjusts the model parameters based on user satisfaction signals derived from acceptance rates of candidate replies. The server can store multiple generative AI models with different parameter sizes and select an appropriate model at runtime based on resource availability or required response latency.

In yet another embodiment, the server deploys the generative AI model across multiple hardware nodes. The server partitions model layers or attention heads across different processing units and coordinates inference execution through a distributed inference framework. By parallelizing computation in this manner, the server increases throughput and reduces response time, particularly when serving many users concurrently. The system thereby provides an improvement in computer technology by optimizing how large neural models are utilized in a communication environment.

The terminal can also be varied. In one alternative embodiment, the terminal may be a wearable device or an in-vehicle communication unit providing a voice-based interface. In such a case, the terminal captures speech, converts the speech to text through a speech recognition module, and delivers the text as communication information to the server. The terminal then converts the received candidate reply text back to speech using a text-to-speech engine. Even in this variant, the server processes structured user characteristic information, constructs prompt sentences, and generates response text in the same manner, illustrating that the core server-side technology is independent of specific terminal hardware.

Through these embodiments, the server improves computer technology by organizing message handling and response generation as a structured data pipeline that optimally utilizes neural models and storage resources, reduces redundant computation, improves personalization accuracy, and lowers latency and communication overhead. The use of explicit prompt sentence construction with embedded structured data, combined with feedback-based updating of user characteristic information, results in a system that operates according to technical rules and algorithms distinct from traditional manual messaging or simple rule-based automation.

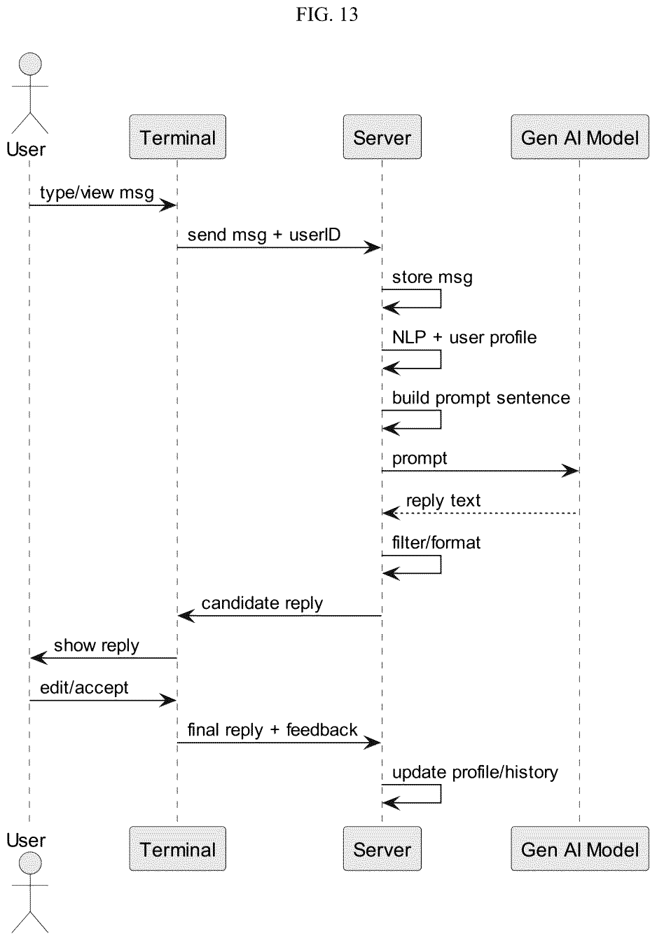

The following describes the processing flow using FIG. 13.
Step 1:

The terminal acquires a new incoming message from a communication partner and prepares request data for the server.

The terminal receives, as input, a message text displayed in a chat interface, along with locally stored user identification information, a conversation identifier, and a timestamp. The terminal performs data processing by packaging these elements into a structured request object, for example a JSON payload including fields for user ID, partner ID, conversation ID, message text, and time. The terminal then outputs this structured request and transmits it to the server over a network using a secure protocol.
Step 2:

The server receives the request from the terminal and stores communication information in association with user identification information.

The server receives, as input, the structured request object containing user identification information and message text. The server performs data validation by checking authentication tokens, verifying that required fields are present, and normalizing character encoding. The server then executes database operations to insert a new record into a communication table, mapping the user identifier and conversation identifier to the message text and timestamp. The server outputs a stored message record identifier and places this identifier into an internal processing queue for subsequent analysis.
Step 3:

The server retrieves the stored message record and executes natural language preprocessing on the message text.

The server receives, as input, the message record identifier from the processing queue and the associated message text from the database. The server performs tokenization, sentence segmentation, and basic text normalization (such as lowercasing where appropriate and removing or standardizing control characters). The server converts the message text into a sequence of token identifiers using a vocabulary associated with the generative AI model. The server outputs a tokenized representation and a normalized text representation, which become inputs to higher-level natural language processing modules.
Step 4:

The server analyzes the tokenized message to extract intent information, topic information, and keyword information.

The server receives, as input, the tokenized message and normalized text from Step 3. The server performs data processing using a natural language understanding module, which may include a classifier neural network or a statistical model. The server computes feature vectors from token embeddings and passes them through one or more classifier layers to predict an intent label and a topic label. In parallel, the server applies a keyword extraction algorithm, such as attention-based weighting over tokens or a statistical scoring method, to identify salient words and phrases. The server outputs a structured analysis result containing intent information, topic information, and keyword information, and stores this analysis result in association with the message record.
Step 5:

The server retrieves preference information and past communication history information to construct user characteristic information.

The server receives, as input, the user identification information and the analysis result from Step 4. The server performs database queries to fetch historical messages, stored user preference entries, and prior statistics (for example, topic frequencies, typical message length, and stylistic indicators) associated with the user. The server then performs data aggregation by computing updated metrics, such as weighted averages of topic interests and counts of previously used expressions. The server merges these values into a unified structured data object representing user characteristic information. The server outputs this user characteristic information as a data structure that can be used for prompt sentence generation.
Step 6:

The server generates a prompt sentence for the generative AI model by combining analysis results and user characteristic information.

The server receives, as input, the intent information, topic information, keyword information, user characteristic information, and the original message text. The server executes template-based string assembly, where predefined instruction segments are filled with dynamic values extracted from the input data. For example, the server inserts user preference descriptions, detected intent, detected topic, and the partner's latest message into specific placeholders in a template. The server thereby performs data transformation from structured objects into a single textual instruction string. The server outputs a prompt sentence, such as:
“You are an assistant that writes chat replies on behalf of the user in a communication service.
User's language: Japanese.
User's preferences: likes science fiction movies and tends to use a casual tone.
Conversation partner's latest message: ‘Any recommendations for movies you've seen recently?’
Detected intent: ask_recommendation
Detected topic: movies
Task: Considering the user's preferences and speaking style, generate a short, natural reply in Japanese that recommends one or two movies. Keep it within two sentences and make it sound like a human chat message.”
Step 7:

The server embeds structured data into the prompt sentence to condition the generative AI model.

The server receives, as input, the prompt sentence from Step 6 and the structured user characteristic information and analysis result. The server performs data formatting by converting key-value pairs, such as topic weights and style parameters, into human-readable clauses appended to the prompt. For example, the server may add text such as “User strongly prefers science fiction and often mentions specific movie titles.” The server integrates these clauses into the prompt sentence according to a predetermined ordering to avoid ambiguity. The server outputs an enriched prompt sentence that encodes both unstructured instructions and structured context, ready for input to the generative AI model.
Step 8:

The server executes inference on the generative AI model using the enriched prompt sentence and generates response text.

The server receives, as input, the enriched prompt sentence from Step 7. The server converts the prompt sentence into token identifiers using the model's tokenizer and loads the corresponding token embeddings into memory. The server then performs forward propagation through the layers of the generative AI model, computing attention scores, intermediate hidden states, and output probability distributions over the vocabulary at each time step. The server applies a decoding algorithm, such as greedy decoding or beam search, to select a sequence of output token identifiers based on the probability distributions. The server converts the selected token identifiers back into natural language text. The server outputs raw response text that represents a candidate reply corresponding to the input communication information.
Step 9:

The server applies post-processing to the generated response text, including inappropriate expression detection, length adjustment, and format normalization.

The server receives, as input, the raw response text from Step 8. The server first applies an inappropriate content classifier or a set of rule-based filters to detect offensive or disallowed terms. When problematic content is found, the server performs data editing by replacing or removing specific tokens or, if necessary, re-invoking the generative AI model with a modified prompt sentence that includes stronger content restrictions. Next, the server computes the character or token length of the response text and compares it with configured limits. If the text is too long, the server identifies sentence boundaries and truncates or summarizes the text while preserving semantic completeness. Finally, the server standardizes punctuation, whitespace, and character usage in accordance with locale-specific rules. The server outputs a post-processed response text that is safe, appropriately sized, and well formatted.
Step 10:

The server sends the post-processed response text to the terminal as a candidate reply and records it as part of the communication information.

The server receives, as input, the post-processed response text from Step 9 and the corresponding user identification information and conversation identifier. The server performs data packaging by constructing a response object containing the candidate reply, metadata such as generation time and model identifier, and a reference to the original message. The server updates the communication record in the database to include the generated candidate reply and its status (for example, “suggested to user”). The server outputs this response object and transmits it to the terminal using a secure network protocol.
Step 11:

The terminal displays the candidate reply to the user and collects feedback based on user actions.

The terminal receives, as input, the response object from Step 10. The terminal parses the object to extract the candidate reply and associated metadata. The terminal then updates the user interface to display the candidate reply within the current conversation context, for example as a suggested message above the input field. The terminal records user actions as feedback data, including whether the user taps to accept the candidate reply, edits the text, or dismisses it. When the user edits the reply, the terminal calculates differences between the candidate reply and the final message, for example by computing character-level or token-level edit operations. The terminal outputs the final response text and feedback data to the server.
Step 12:

The server updates user characteristic information based on the final response text and feedback data from the terminal.

The server receives, as input, the final response text, the candidate reply, and feedback data indicating acceptance, rejection, or degree of editing. The server performs statistical analysis by comparing the candidate reply and final text to identify which parts were modified, such as shortened segments, changed word choices, or removed expressions. The server then updates preference weights and style parameters in the user characteristic information using predefined update rules, such as increasing a preference weight for brevity when the user consistently shortens messages. The server also stores the final response text in the communication history and marks the candidate reply as accepted or edited. The server outputs updated user characteristic information that will influence subsequent prompt sentence generation and model conditioning.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented communication and content delivery systems primarily treat user messages and viewing behavior as static input signals and generate fixed or rule-based responses. Such systems suffer from several technical limitations.

First, a conventional server typically performs only shallow analysis of text data, for example by applying keyword matching or static sentiment tags, and does not continuously track temporal changes in a user's emotional state. As a result, the server cannot adapt the style and tone of generated responses over time. This leads to context-insensitive outputs that can degrade user engagement and increase the need for manual corrections, thereby wasting network bandwidth and processor cycles on ineffective or repeated interactions.

Second, in many systems that invoke a generative AI model, the construction of a prompt sentence is static and does not integrate heterogeneous context signals such as user attribute information, detailed communication history, current content being consumed, and dynamically estimated emotional state. Because of this, the generative AI model often receives incomplete or poorly structured context, which results in suboptimal generations, increased numbers of re-tries, and higher computational load on both the application server and the generative model infrastructure.

Third, existing architectures do not exploit feedback from user operations on AI-generated outputs. In particular, the server does not systematically log whether a user approves, edits, or rejects a generated response, and does not use such usage history to refine subsequent prompt construction. This absence of an adaptive feedback loop prevents the server from optimizing prompts and generation conditions, causing persistent mismatches between user preferences and generated outputs. Consequently, the system experiences unnecessary latency and increased consumption of processing resources, as users frequently modify or ignore generated responses.

Fourth, typical systems handle automated reply and recommendation functions in a fragmented manner: emotion analysis, content recommendation, and auto-reply for messaging services are often implemented as separate modules with limited coordination. This fragmentation prevents efficient re-use of intermediate analysis results (for example, emotion profiles and behavior tendencies) across services. It also leads to redundant computations and inconsistent behavior across communication channels, which is a technical inefficiency in the overall data processing pipeline.

There is therefore a need for a computer-implemented system and server-side processing architecture that: (i) performs integrated analysis of user attribute information, communication history, and emotion over time; (ii) dynamically constructs rich prompt sentences for a generative AI model by combining multiple layers of contextual signals; (iii) adapts the expression style and dialogue tone of generated responses based on temporal emotion tracking; and (iv) closes a feedback loop by using user approval or modification history to update prompt-generation logic and response-generation conditions. By addressing these issues at the level of server-side data processing and model interaction, the invention aims to improve the technical functioning of communication and content delivery systems, including more efficient use of processor and network resources, reduced need for repeated model invocations, and improved quality and relevance of machine-generated outputs.

The specific processing by the specific processing unit 290 of the data processing device 12 in Application Example 2 is realized by the following means.

The present invention provides a server comprising a processor configured to acquire user attribute information and past communication history from a storage apparatus, analyze the attribute information and the communication history by using natural language processing technology and an emotion analysis function so as to identify an emotional state and a behavioral tendency of a user, construct a prompt sentence for input to a generative information processing model on the basis of the emotional state of the user, the behavioral tendency of the user, and context information related to information providing content or a communication situation being used by the user, transmit the prompt sentence to the generative information processing model so as to cause the generative information processing model to generate response information, track a temporal change of the emotional state of the user and adjust an expression style and a dialogue tone of the response information in accordance with the temporal change, and accumulate usage history indicating whether the user has approved or modified the response information and update a generation method of the prompt sentence or a generation condition of the response information on the basis of the usage history. This enables the server to dynamically supply the generative information processing model with richer and better-structured context, to automatically adapt generated responses to evolving emotional conditions, and to iteratively refine prompt generation based on actual user interactions, thereby improving the technical performance and efficiency of the underlying communication and content delivery infrastructure.

The term “user attribute information” refers to information indicating characteristics of a user, including at least one of demographic properties, preference tendencies, behavioral patterns, and profile settings, which is stored or derived from data managed by the system.

The term “communication history” refers to stored records of message exchanges, interactions, or other communication events between a user and at least one counterpart or service, including timestamps, message contents, and associated metadata.

The term “natural language processing technology” refers to a collection of software-based techniques for processing human language text, including operations such as tokenization, morphological analysis, part-of-speech tagging, syntactic analysis, semantic analysis, and entity recognition.

The term “emotion analysis function” refers to a software-implemented function or module that estimates an emotional state or sentiment of a user from text data or other input signals by applying emotion classification, sentiment scoring, or related computational analysis.

The term “emotional state” refers to a condition of a user's affective status, such as positive, neutral, negative, or more granular categories including joy, sadness, anger, or anxiety, as determined by the emotion analysis function.

The term “behavioral tendency” refers to a pattern in a user's actions or communication style, including at least one of responsiveness level, typical tone, preferred topics, and interaction frequency, identified by analysis of communication history and attribute information.

The term “context information” refers to information representing a situation relevant to processing by the system, including at least one of information providing content being viewed or used by the user, current communication session state, and summary information of recent dialogue or interactions.

The term “information providing content” refers to digital content supplied through a service, including at least one of audiovisual content, textual content, interactive content, and associated descriptive data such as titles, categories, and summaries.

The term “communication situation” refers to a state of an ongoing or recent communication session involving the user, including counterpart identifiers, recent exchanged messages, and channel or application type.

The term “generative information processing model” refers to a machine-implemented model, such as a generative AI model, that receives an input including a prompt sentence and generates new text or other output data based on learned statistical relationships.

The term “prompt sentence” refers to an input text or structured textual instruction provided to the generative information processing model, the input text including contextual information and directives that cause the model to generate response information according to a desired task.

The term “response information” refers to information generated by the generative information processing model in response to a prompt sentence, including at least one of reply text, question text, comment text, and recommendation explanation text.

The term “expression style” refers to a set of characteristics of response information related to wording and format, including at least one of politeness level, formality level, length, and degree of detail.

The term “dialogue tone” refers to an affective and communicative nuance of response information, including at least one of friendly, neutral, empathetic, enthusiastic, or calm tone, as controlled or adjusted by the system.

The term “temporal change of the emotional state” refers to variation of the user's emotional state over time, derived from multiple emotion analysis results collected across a sequence of interactions.

The term “usage history” refers to data indicating how a user has handled generated response information, including at least one of approval, modification, rejection, or non-use of such generated response information.

The term “generation method of the prompt sentence” refers to a procedure or set of rules for constructing a prompt sentence, including selection and combination of context information, formatting of instructions, and encoding of desired tone or style.

The term “generation condition of the response information” refers to one or more parameters or constraints controlling operation of the generative information processing model, including at least one of desired length, tone, style, topic focus, and response type.

The term “user terminal” refers to an electronic apparatus operated by a user, including at least one of a mobile communication device, a computing device, and a display device, which sends data to and receives data from the server.

The term “external communication infrastructure” refers to a communication network or platform that mediates data exchange between the server, user terminals, and external services, and includes at least one of wired networks, wireless networks, and application-level communication platforms.

The term “information providing infrastructure” refers to a server-side or cloud-based platform that stores and delivers information providing content or communication services, and that can be accessed by the system to distribute response information or associated content.

In one embodiment, a server cooperates with at least one user terminal operated by a user and with one or more communication or content delivery platforms over a communication network. The server includes at least one processor, a memory storing computer programs and data structures, and one or more communication interfaces. The terminal includes at least one processor, a memory, a display device, an input device, and a communication interface. The user interacts with the terminal to consume digital content and to exchange messages, while the server performs analysis and generation operations based on data received from the terminal and external services.

The server executes a program implemented, for example, in a high-level programming language running on a general-purpose computing platform. In one implementation, the server uses a multi-core central processing unit and, optionally, one or more graphics processing units to accelerate neural network inference. The server stores user-related data and processing results in one or more storage devices, such as a relational database system or a key-value data store.

The server uses software libraries for natural language processing and for emotion analysis. In one example, the server includes a natural language processing module implemented with a language processing library configured to perform tokenization, part-of-speech tagging, syntactic dependency parsing, lemmatization, and named entity recognition. The server further includes an emotion analysis module implemented with an emotion analysis engine or an external sentiment analysis service. The emotion analysis module classifies input text into one or more emotion categories and outputs numeric scores representing intensity values for different emotions.

The server uses a generative AI model as a generative information processing model. In one embodiment, the generative AI model is an attention-based neural network, such as a transformer model, comprising an embedding layer, a plurality of self-attention layers, feed-forward layers, and a final output layer for predicting token probabilities. The generative AI model is trained in advance using a large corpus of training text, through supervised or semi-supervised learning, by minimizing a loss function such as cross-entropy between predicted token distributions and ground-truth tokens. During training, the server or an external training system updates model parameters using gradient-based optimization, such as stochastic gradient descent with adaptive learning rate, and may apply regularization techniques such as dropout and layer normalization. The server may also apply data augmentation methods, such as masking tokens, shuffling sentence segments, or injecting paraphrases, to improve robustness of the generative AI model.

The server stores the generative AI model locally or accesses it through a model-serving interface. The server uses a standardized data structure to communicate with the model, for example a sequence of tokens representing a prompt sentence. The server converts the prompt sentence from text to tokens using a tokenizer associated with the model, passes the token sequence to the model, and receives output tokens. The server then converts the output tokens back to text to obtain response information.

The server maintains several data structures in the memory and storage apparatus. In one example, the server stores user attribute information in a user profile table, with fields such as user identifier, preference vector, communication style features, and activity statistics. The server stores communication history in a conversation history table, where each record includes a user identifier, a counterpart identifier or service identifier, a message identifier, timestamp, message content text, channel type, and flags indicating whether the message was generated by the system or by the user. The server stores emotion state information in an emotion state table, with fields including user identifier, message identifier, emotion category, and numeric emotion scores. The server stores generation logs in a generation log table, including the prompt sentence, the generated response information, and usage history indicating whether the user approved, modified, or rejected the response information.

The server uses specific feature extraction algorithms to convert raw text data into numerical features for subsequent analysis. The server computes term frequency and inverse document frequency for terms appearing in communication history, and generates feature vectors representing topics or preference tendencies. The server also computes statistics on message length, response latency, and the presence of specific linguistic markers such as polite expressions, emoticons, or intensifiers, to determine behavioral tendencies such as talkativeness, typical tone, and responsiveness.

The terminal operates as an interface for the user. The terminal sends user inputs to the server and displays results from the server. The user enters messages, approvals, corrections, and content selection inputs through the terminal. The terminal may be implemented as a smartphone, tablet, personal computer, or other computing device. The terminal executes an application that communicates with the server through an application programming interface over a network protocol such as HTTP or WebSocket.

The server analyzes user messages and viewing behavior over time to identify temporal changes in emotional state. The server receives sequences of messages from the terminal and passes each message through the natural language processing module. The server obtains token sequences and syntactic structures and forwards them to the emotion analysis module. The server receives emotion category labels and numeric intensity scores. The server aggregates emotion results for recent messages using a sliding time window and computes moving averages or temporal gradients of emotion scores. When the server detects significant change, such as a shift from positive to negative emotion, the server updates an emotion profile entry in the storage apparatus. This temporal emotion tracking enables the server to recognize non-static emotional characteristics and to adjust response generation accordingly.

The server constructs a prompt sentence for the generative AI model by integrating multiple types of context information. The server retrieves user attribute information, including preference vectors and communication style parameters, from the user profile table. The server retrieves recent communication history entries within a defined context window, and may summarize them into a condensed context text using rule-based templates or an auxiliary summarization model. The server also retrieves content-related information, such as the title and genre of a currently viewed media item, from a content information table or an external content service. The server retrieves the current emotion state and temporal emotion trend from the emotion state table and emotion profile.

The server arranges these pieces of information into a prompt sentence. The server may use a template such as:
“The user is using a communication service. Here are the last messages in the conversation: [conversation summary]. The user profile: prefers friendly and casual expressions, likes movies and outdoor activities. The user's current emotional state is slightly tired but positive. Generate a friendly and concise reply in one or two sentences.”

In another example, the server may use a prompt sentence such as:
“The user is watching the movie ‘Titanic’ and currently feels moved and emotional. Generate a short, empathetic comment about the ending that invites the user to reflect, but do not spoil details beyond what most viewers know.”

In another example related to content recommendation, the server may use a prompt sentence such as:
“Based on this profile: prefers romantic and emotional movies, recently commented ‘This movie was very touching’, and is currently in a happy and relaxed mood, recommend three moving films and explain in one sentence each why they might appeal to the user.”

The server embeds instruction phrases in the prompt sentence that explicitly indicate the desired output type, such as reply text, question text, comment text, or recommendation explanation text. The server also encodes constraints such as maximum length, politeness level, and avoidance of spoilers or sensitive topics. The server thus generates prompt sentences that are richer and more structured than conventional prompts that include only a small amount of conversation text.

The server transmits the prompt sentence to the generative AI model. The generative AI model performs a sequence of internal operations including token embedding, multi-head self-attention over the prompt tokens, feed-forward transformation, and iterative prediction of next tokens. The generative AI model uses its internal representations, which have been trained to capture semantic relationships and discourse patterns, to generate a coherent and context-aware response. The server controls parameters such as temperature, top-k sampling, or nucleus sampling thresholds to adjust the diversity and determinism of the generated text.

The server receives the generated response information and executes post-processing. The server applies a moderation module to the generated text to check for prohibited expressions or policy violations, using rule-based filters and, optionally, a secondary classifier. The server automatically enforces length constraints and may perform a rephrasing operation when the generated text deviates from a desired style. For example, the server can submit a second prompt sentence instructing the generative AI model to “rewrite the following reply in a slightly more gentle and empathetic tone, keeping the meaning,” followed by the initially generated reply. This two-stage adjustment process allows the server to fine-tune the response style in a systematic way, relying on an explicit instruction rather than manual rewriting.

The server sends the final response information to the terminal. The terminal displays the response suggestion in a dedicated user interface area. The user can approve the suggestion as-is, edit the text, or reject the suggestion. The terminal reports the user's action back to the server. The server records whether the user approved, modified, or discarded the response information in the generation log table and the usage history table.

The server uses the accumulated usage history to update the generation method of the prompt sentence and the generation conditions of the response information. The server performs statistical analysis to determine patterns such as systematic shortening of responses by the user, systematic strengthening of politeness markers, or frequent rejection of certain tones or topics. The server adjusts internal parameters for prompt construction, such as preferred length range, default tone, or the degree of detail to be requested from the generative AI model. The server may adjust model-level parameters such as temperature or maximum token count to reduce the occurrence of undesired output patterns. By iteratively refining these parameters, the server converges toward a configuration in which the generative AI model's outputs better align with user preferences, reducing the rate of rejections and modifications.

The server's processing improves the functioning of the computer system in multiple technical aspects. By integrating emotion analysis, temporal emotion tracking, and context-rich prompt construction into a unified pipeline, the server reduces the number of times the generative AI model must be invoked to obtain an acceptable output. As a result, the server reduces computational load on the neural network inference engine and lowers latency experienced by the user. By adjusting prompt sentences based on observed user behavior, the server increases the precision of generated responses, which decreases redundant network traffic caused by repeated sending of revised messages or by follow-up clarifications. The server's emotion-state aggregation and profile update algorithms are implemented as efficient numerical operations, such as incremental aggregation and sliding-window statistics, which minimize memory access overhead and avoid recomputation of emotion metrics for older messages.

The system does not merely automate human drafting of replies. The server employs non-conventional processing sequences and machine-specific rules that are not the same as a human writer's reasoning process. For example, the server uses internal emotion scores, word frequency vectors, and token-level attention patterns to decide which contextual elements to include in each prompt sentence. The server may weight different parts of the conversation according to a metric derived from attention distributions or from emotion intensity values, rather than simply taking the last few sentences. The server may apply a rule such as “include the message with maximum recent negative emotion, even if it lies outside the last N messages,” which is a machine-oriented heuristic not typically available in manual composition. These technical procedures result in a prompt structure that improves the generative AI model's ability to produce contextually appropriate outputs with fewer tokens of input and output, leading to improved computational efficiency.

In another embodiment, the server cooperates more closely with external services. The server directly interfaces with a communication platform or content delivery platform through an application programming interface. When the server determines that the user is in a busy or response-difficult state, based on behavior such as delayed responses or explicit user settings, the server automatically transmits generated response information through the platform's message-sending interface. The platform receives the response as if it were sent from the user's account. The server records these automatic transmissions and their timing, and can adjust sending policies to avoid overloading network resources or causing throttling. By coordinating automatic responses with platform-specific rate limits, the server reduces the risk of repeated failed transmission attempts and improves reliability and throughput of the communication system as a whole.

In another embodiment, the server uses the same internal emotion profile and usage history both for message generation and for content recommendation. The server computes a joint representation of the user's current mood, long-term preferences, and recent interaction outcomes. The server then constructs a prompt sentence that instructs the generative AI model to generate recommendations, such as “Based on the user's current sad mood and past preference for lighthearted comedies, recommend three comforting movies and explain briefly why each might help improve the mood.” The server uses the generated descriptions in combination with a separate retrieval engine that selects candidate items from a database. The server then ranks the candidates using a scoring function that takes into account both model-generated explanations and numerical similarity metrics. This integration reduces the need to run multiple independent recommendation and explanation systems and thereby decreases processing overhead. The improved alignment between recommendations and user mood also reduces unnecessary content loading and streaming, contributing to lower network bandwidth usage.

In a further embodiment, the server uses different variants of the generative AI model with different parameter counts and architectures, such as a larger, more expressive model for offline generation of templates and a smaller, faster model for real-time generation. The server selects among these variants based on latency constraints and context complexity. For example, the server may use a smaller model for short replies in a high-traffic chat session, while using a larger model for generating more detailed recommendation texts when the user is browsing content. This heterogeneous model deployment enhances throughput and reduces average response time without sacrificing quality where more elaborated text is needed.

The terminal may implement additional logic to pre-process user inputs before sending them to the server. For example, the terminal can locally perform simple text normalization, language detection, or input categorization, and encode metadata that helps the server select the appropriate processing pipeline. The terminal can also cache previously received response patterns for specific recurrent situations, which allows the terminal to suggest responses even when network connectivity is temporarily degraded, and later synchronize with the server once connectivity is restored. The cooperation between terminal-side pre-processing and server-side advanced processing contributes to an overall reduction in network usage and improved user-perceived responsiveness.

Alternative embodiments may vary the underlying algorithms while maintaining the essential features of the system. In one alternative, the server replaces a transformer-based generative AI model with a recurrent neural network architecture or a hybrid architecture combining convolutional and attention-based layers, while still using prompt sentences to control output. In another alternative, the server uses a different error function during training, such as a combination of cross-entropy and an auxiliary loss that encourages emotion-consistent outputs, so that generated responses better match the intended emotional tone. In another alternative, the server incorporates reinforcement learning from user feedback, where the server assigns positive rewards to generated responses that are frequently approved by users and negative rewards to those frequently rejected, and uses these rewards to fine-tune the generative AI model or to refine prompt construction policies.

The user remains in control of the system's behavior. The user may configure preferences such as maximum level of automation, allowed tone types, or types of services (messaging, comments, recommendations) that may be automatically generated. The user interacts with the terminal to provide such settings, and the terminal transmits these settings to the server. The server respects these constraints by, for instance, only generating suggestions without automatic sending when the user chooses a confirmation requirement. The system thus maintains flexibility and user control while providing a technically advanced architecture that improves computational efficiency, response quality, and resource utilization in communication and content delivery environments by using generative AI models and context-rich prompt sentences in a novel, machine-optimized manner.

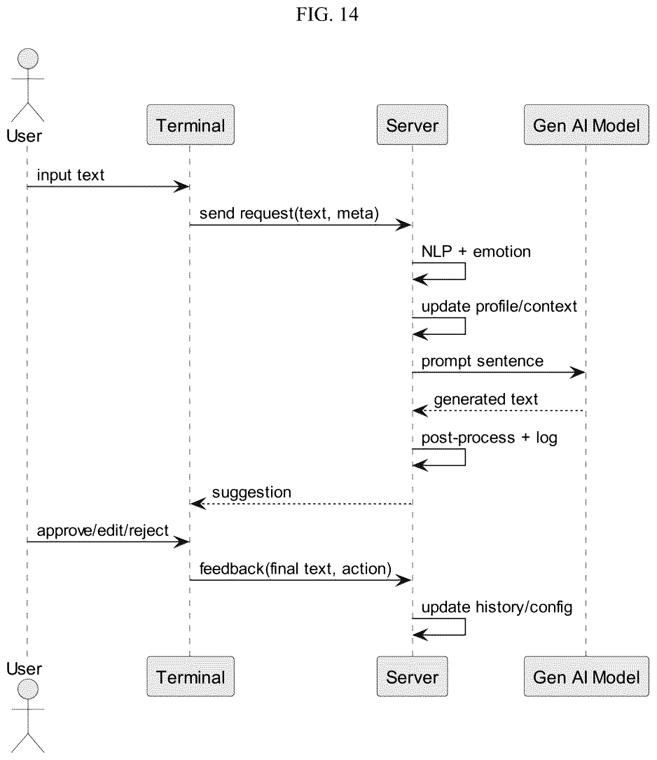

The following describes the processing flow using FIG. 14.
Step 1:

User operates the terminal to input text and interact with services.

User enters one or more messages, comments, or instruction texts into the terminal, such as
“I'm busy, please reply for me,” “What are your plans for the weekend?”, or “Recommend a touching movie.”

Input: raw text typed or selected by the user, together with implicit context such as which application screen is active (chat, streaming, recommendation).

Output: structured input events at the terminal side.

User triggers sending by pressing a send or confirm button, so that the terminal can package the input for transmission.
Step 2:

Terminal acquires local context and transmits a request to the server.

Terminal collects the user's input text, a user identifier, application type (messaging, streaming, recommendation), current content identifier (for example, a movie ID or chat thread ID), and a timestamp.

Input: raw user text and local metadata (user ID, app screen, content ID, device time).

Terminal converts these data into a structured request (for example, a JSON object in memory) and may normalize encodings (UTF-8) and line breaks.

Output: a network-ready request message sent to the server over a communication channel, containing user text and associated metadata.
Step 3:

Server receives the request and stores raw data.

Server accepts the incoming request through a communication interface, verifies authentication tokens, and checks that mandatory fields (user ID, text, content ID) are present.

Input: structured request message from the terminal.

Server writes the raw text and metadata into storage tables such as a conversation history table and a user interaction log, associating them with the user identifier and current session. The server may assign a unique message identifier.

Output: persistent records of the new interaction, including message ID, user ID, text content, and context fields.
Step 4:

Server performs natural language preprocessing on the received text.

Server loads the stored message content and applies a natural language processing module to segment the text into tokens, perform part-of-speech tagging, and detect named entities (for example, movie titles or locations).

Input: message text strings retrieved from the conversation history and associated metadata.

Server executes string normalization (lowercasing, removing extra whitespace), tokenization (splitting on word boundaries), and morphological analysis (lemmatization) to obtain canonical tokens. Server stores token sequences and linguistic annotations in an auxiliary data structure linked by message ID.

Output: preprocessed text representation including tokens, part-of-speech tags, and entities for each message.
Step 5:

Server applies emotion analysis to estimate the user's emotional state.

Server passes the preprocessed text to an emotion analysis function or API that classifies the emotional content of the message.

Input: tokenized and normalized message text, along with possibly detected entities or syntactic context.

Server invokes the emotion analysis engine, which computes sentiment scores (for example, positive, neutral, negative) and, optionally, emotion category scores (for example, joy, sadness, anger, fear), using a trained classifier. Server then records these scores together with a derived label, such as “joy” or “frustration,” into an emotion state table keyed by user ID and message ID.

Output: an emotion state record containing emotion labels and numeric intensity values associated with the message.
Step 6:

Server aggregates emotion states over time to track temporal change.

Server retrieves recent emotion state records for the user within a defined time window, such as the last N messages or last M minutes.

Input: a sequence of recent emotion scores and timestamps associated with a user.

Server performs numerical aggregation, such as computing moving averages of each emotion dimension and calculating differences between current and previous scores. Server determines whether a significant change, for example from “neutral” to “sad” or from “calm” to “irritated,” has occurred, based on threshold comparisons. Server updates a user emotion profile with current dominant emotion and a trend indicator (increasing, decreasing, or stable).

Output: an updated emotion profile entry describing the user's current emotional state and its temporal trend.
Step 7:

Server updates user attribute information and behavioral tendencies.

Server analyzes the broader communication history and interaction patterns to refine user profile data.

Input: accumulated message records, token statistics, response times, and previously computed features for the user.

Server computes term frequencies and topic indicators from message content, calculates average message length, measures typical reply delays, and detects frequent stylistic markers such as politeness phrases. Server updates a user profile structure to reflect preference vectors (for example, genres liked) and behavioral tendencies (for example, talkative and casual).

Output: a refined user attribute profile that captures long-term preferences and communication style parameters.
Step 8:

Server gathers content and session context information.

Server identifies what content or service the user is currently using, such as a specific video, a chat partner, or a recommendation screen.

Input: content ID, application type, and any available metadata from a content catalog or external platform API.

Server queries a content information database or external service to obtain details such as title, category, synopsis, and relevant tags. For a chat session, the server also retrieves the last several messages and, if necessary, summarizes them into a short description.

Output: structured context information describing the current content or conversation and recent discourse context.
Step 9:

Server constructs a context-rich prompt sentence for the generative AI model.

Server integrates user attribute information, current emotion profile, conversation or content context, and usage constraints to formulate a prompt sentence.

Input: user profile data, emotion profile, recent dialogue summary or content description, and task type (reply, question, comment, or recommendation).

Server places these elements into a text template or a set of template rules to form an instruction such as:
“The user is using a communication service. Here are the last messages in the conversation: [conversation summary]. The user profile: prefers friendly and casual expressions, likes movies and outdoor activities. The user's current emotional state is slightly tired but positive. Generate a friendly and concise reply in one or two sentences.”

Server ensures that the prompt sentence includes explicit directives about tone, length, and type of output.

Output: a complete prompt sentence ready for input into the generative AI model.
Step 10:

Server encodes the prompt sentence and sends it to the generative AI model.

Server converts the prompt sentence into tokens using a tokenizer associated with the generative AI model and prepares an inference request.

Input: prompt sentence text.

Server applies the tokenizer to split the text into subword units and map them to integer token IDs. Server packs the token IDs and model parameters (such as maximum output length and sampling temperature) into a model input structure and transmits this structure to the generative AI model, either locally via an inference library or remotely via a model-serving API.

Output: a model invocation request containing encoded prompt data submitted to the generative AI model.
Step 11:

Server obtains generated response information from the generative AI model.

Server receives the model's output, which consists of a sequence of predicted tokens representing the generated text.

Input: token probability distributions or selected token IDs produced by the generative AI model.

Server decodes the token IDs back into text, reconstructing a reply, question, comment, or recommendation explanation. Server then attaches metadata such as the originating prompt ID and model configuration.

Output: raw generated response information in textual form, associated with the corresponding prompt and user.
Step 12:

Server post-processes the generated response information.

Server evaluates the generated text for length, style, and compliance with safety and policy constraints.

Input: generated text and associated metadata, including the target tone and maximum allowed length.

Server truncates or adjusts the text if it exceeds length limits, executes keyword or pattern checks to detect prohibited content, and, when necessary, constructs a secondary prompt sentence such as “Rewrite the following reply in a slightly more gentle and empathetic tone, keeping the meaning: [generated text]” and re-invokes the generative AI model. Server then selects or refines the final version of the response information.

Output: sanitized and style-adjusted response information suitable for presentation to the user or for automatic sending.
Step 13:

Server records usage context and prepares data for future adaptation.

Server logs the constructed prompt sentence, the generated response information, and the conditions used for generation.

Input: prompt text, final response text, model parameters, and user identifiers.

Server writes these records into generation log and usage history tables, marking the type of task (reply, question, comment, recommendation) and recording the time of generation. These logs will later be associated with user actions indicating approval or modification.

Output: persistent log entries that map prompt structures to generation outcomes for each user.
Step 14:

Server sends the generated response information to the terminal.

Server packages the response text and relevant metadata into a response message to the terminal.

Input: final generated text, message type, and control flags such as whether auto-sending is allowed.

Server transmits this data via a network interface to the terminal, using a predefined application protocol.

Output: a server-to-terminal response message containing the AI-generated suggestion and instructions on how the terminal should handle it (for example, display only or auto-send).
Step 15:

Terminal displays the generated response and obtains user feedback.

Terminal presents the generated response in an appropriate user interface element, such as a draft reply box or a suggestion card.

Input: response text and handling flags received from the server.

Terminal renders the text on the display, labels it as a suggestion, and provides controls such as “Send,” “Edit,” or “Discard.” The user may accept the response without modification, edit the text, or reject it.

Output: user feedback events indicating approval, modification (with updated text), or rejection.
Step 16:

Terminal transmits the final user decision to the server and/or external platform.

Terminal sends the user's action and, if edited, the final text back to the server, and may also forward the final text to an external communication or content platform.

Input: user-selected action and final text content.

Terminal creates a message containing the user's decision and delivers it to the server. If auto-sending is enabled or if the user presses “Send,” the terminal (or the server, depending on configuration) calls the external platform's messaging or posting API to transmit the final text to a counterpart or to a content service.

Output: network messages to the server for logging and, where applicable, to the external platform for actual message delivery.
Step 17:

Server updates usage history and adapts future prompt generation.

Server receives the user feedback from the terminal and links it to the corresponding generation log entry.

Input: user decision (approved, modified, rejected) and, when applicable, the user-edited text.

Server updates usage history records to indicate which generated responses were accepted without change, which were edited (and how), and which were rejected. Server analyzes these records to adjust internal parameters for future prompt sentence construction, such as typical desired length, level of politeness, or preference for certain tones. Server may compute statistics, such as approval rate per tone or average amount of user editing, and use these statistics to refine prompt templates and model parameters.

Output: updated usage history data and adjusted configuration for subsequent prompt sentences and response generation.
Step 18:

Server optionally performs content recommendation using shared context.

Server uses the same user profile and emotion tracking data to generate content recommendations based on current mood and historical preferences.

Input: user emotion profile, behavioral tendencies, viewing history, and possibly recent comments or ratings.

Server constructs a dedicated prompt sentence, such as “Based on this profile: prefers romantic and emotional movies, recently commented ‘This movie was very touching’, and is currently in a happy and relaxed mood, recommend three moving films and explain in one sentence each why they might appeal to the user,” and passes it to the generative AI model. Server combines the generated recommendation descriptions with a retrieval engine that selects concrete items from a catalog and sends a list of recommended contents back to the terminal.

Output: recommendation results, including item identifiers and human-readable explanations, for presentation to the user and for updating viewing history when selected.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

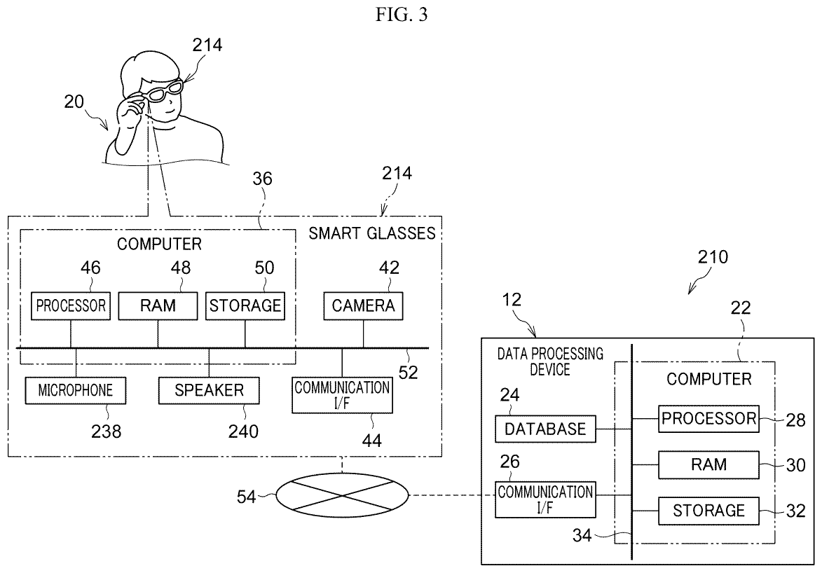

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

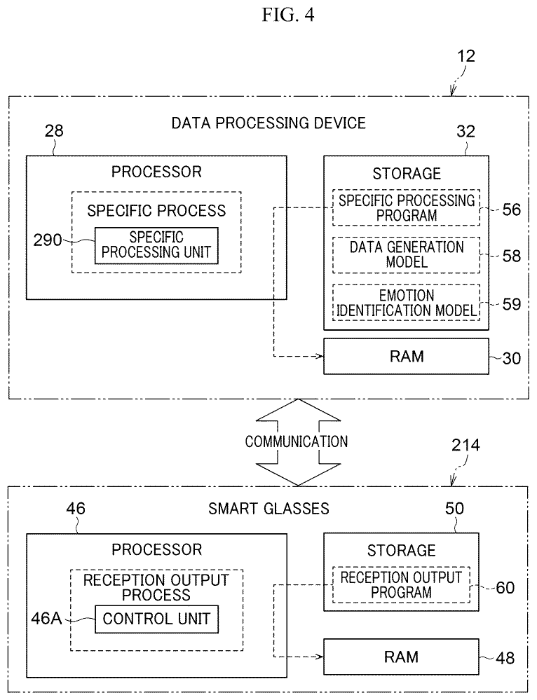

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

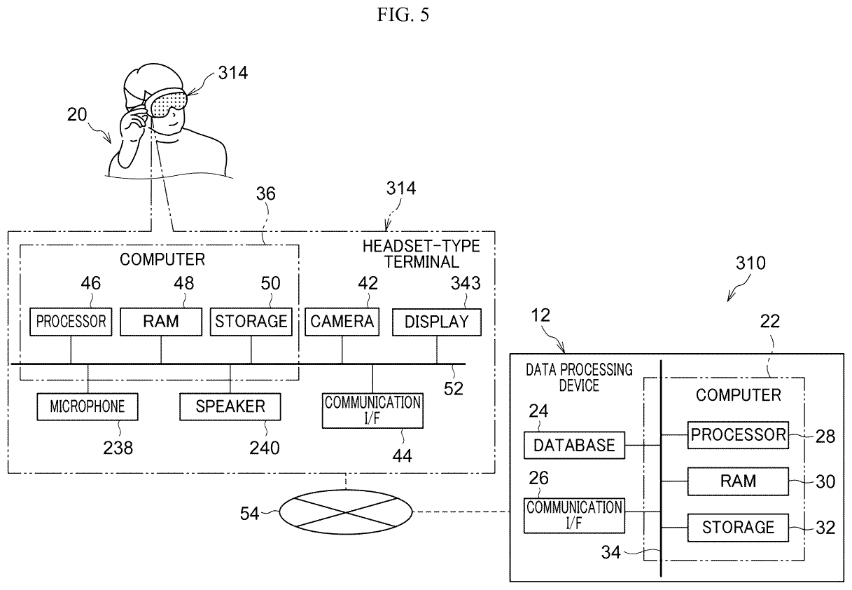

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

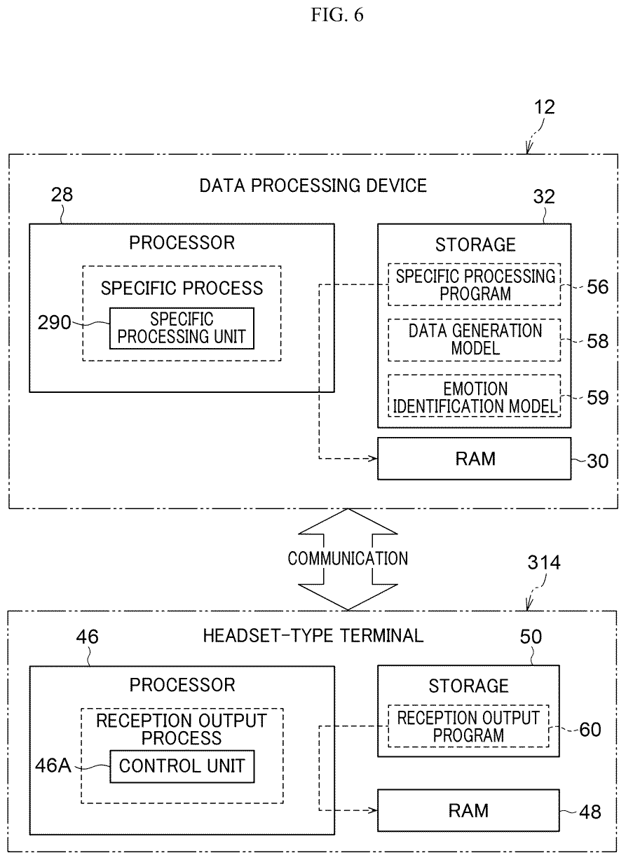

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

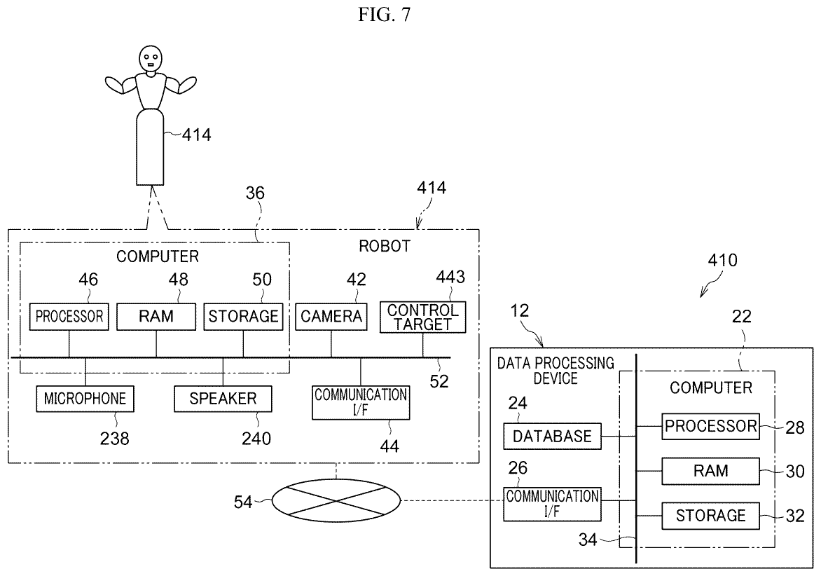

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

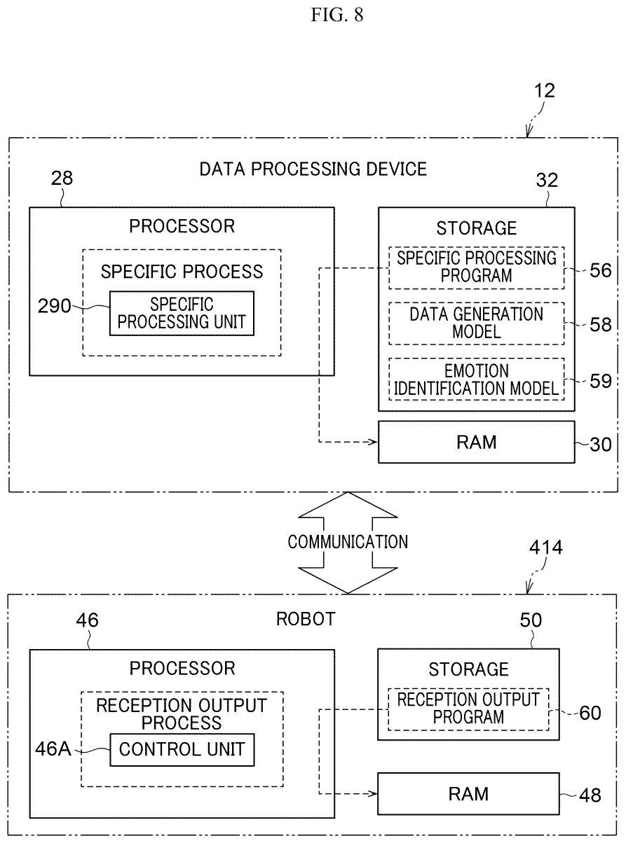

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

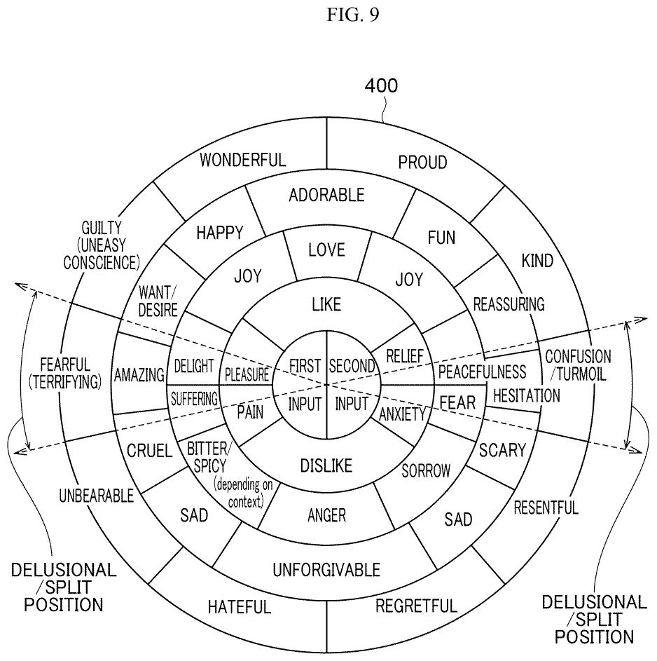

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o′clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

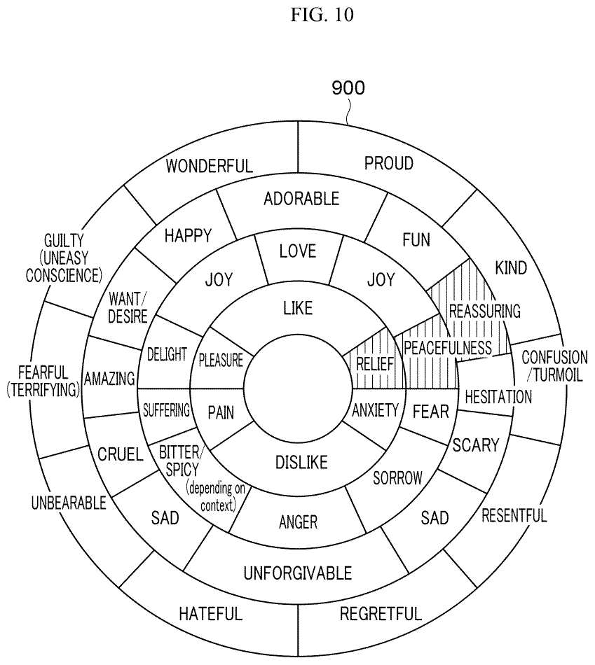

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, based on user identification information, user attribute information and past communication information stored in a storage device, and
analyze the past communication information by using a natural language processing algorithm to divide the past communication information into linguistic units and part-of-speech units, perform occurrence frequency analysis and removal of unnecessary terms to extract a keyword set and a topic group indicating user interests, and recognize a user emotional state by using an emotion analysis algorithm, and
generate, based on the keyword set, the topic group, the user emotional state, and latest message content from a communication partner, a prompt sentence including conditions relating to a user personality tendency, a conversation context, a desired writing style, and a response length, by performing template processing, and configure the prompt sentence as input data for a generative AI model, and
transmit the prompt sentence to the generative AI model via an external interface and receive a response candidate text obtained from the generative AI model, and
perform filtering processing and formatting processing on the response candidate text based on a content restriction rule or a safety determination algorithm to determine a substitute response message for the user, and
transmit the substitute response message to a communication terminal and cause the communication terminal to transmit the substitute response message to the communication partner on an online communication service.

### (Supplementary 2)

The system according to supplementary 1,
wherein the processor is configured to
convert the past communication information into a vector representation by using a word embedding model or a sentence embedding model, derive the topic group by using a clustering method, and dynamically select conversation theme information to be included in the prompt sentence based on the topic group.

### (Supplementary 3)

The system according to supplementary 1,
wherein the processor is configured to
access the generative AI model via a network-based application programming interface as the external interface, use a large language model as the generative AI model, and automatically generate a natural reply adapted to the user interests and the user emotional state in a dialogue with a matching partner in a matching support service.

### Application Example 1

### (Supplementary 1)

A system comprising a processor,
wherein the processor is configured to
acquire attribute information and history information of a user from a storage device based on identification information for identifying the user, and extract the history information corresponding to the user from the storage device,
preprocess the acquired history information by executing an information processing program to generate numerical features and categorical features, and execute a machine learning model using the numerical features and the categorical features to estimate an attribute profile indicating preferences and interests of the user,
construct an input text including the attribute profile and a set of content information, and
generate a prompt sentence to be input to a generative artificial intelligence model,
analyze response information obtained from the generative artificial intelligence model,
extract recommendation target information from the set of content information based on an identifier included in the response information, and generate a recommendation list including justification information for the recommendation target information,
transmit the recommendation list to a terminal device and cause the terminal device to present the recommendation target information visually or audibly, and
accumulate, as the history information, usage behavior information regarding the recommendation target information transmitted from the terminal device into the storage device, and reflect the usage behavior information in subsequent analysis and
recommendation performed by the machine learning model and the generative artificial intelligence model.

### (Supplementary 2)

The system according to supplementary 1,
wherein the processor is configured to cause the machine learning model to output a probability distribution indicating preferred fields of the user and an interest vector based on the features extracted from the history information, and to cause the prompt sentence to have an information structure in which profile information of the user including the preferred fields and the interest vector is supplied to the generative artificial intelligence model.

### (Supplementary 3)

The system according to supplementary 1,
wherein the processor is configured to cause the generative artificial intelligence model to perform natural language reasoning on selection criteria and prioritization of the recommendation target information based on the profile information of the user and the set of content information included in the prompt sentence, and to include a reasoning result obtained by the natural language reasoning as the justification information for each piece of the recommendation target information in the recommendation list.

### Example 2

### (Supplementary 1)

A system comprising a processor,
wherein the processor is configured to
receive communication information obtained from a user terminal together with user identification information, and store the communication information in association with the user identification information in an information storage device,
analyze natural language text included in the communication information by executing natural language processing and semantic analysis using a generative AI model, and extract intent information, topic information, and keyword information,
acquire, from the information storage device, preference information and past communication history information associated with the user identification information, and integrate the acquired information as user characteristic information,
generate, based on the intent information, the topic information, the keyword information, and the user characteristic information, a prompt sentence for input to the generative AI model, the prompt sentence including response generation conditions,
input the prompt sentence to the generative AI model to cause the generative AI model to generate response text, and perform post-processing on the generated response text, the post-processing including at least inappropriate expression detection, length adjustment, and format normalization, and
transmit the post-processed response text to the user terminal, and register, as communication history information in the information storage device, final response text that is transmitted after confirmation or editing by a user.

### (Supplementary 2)

The system according to supplementary 1,
wherein the processor is configured to perform, prior to inputting the prompt sentence to the generative AI model, preprocessing that structures at least part of the communication information and at least part of the user characteristic information as structured data, and embed the structured data into the prompt sentence so as to condition generation of the response text by the generative AI model.

### (Supplementary 3)

The system according to supplementary 1,
wherein the user terminal is a communication device that transmits and receives messages in a communication service for mediating interpersonal encounters, and the processor is configured to present the response text as a candidate reply to a message exchanged with a matched communication partner in the communication service, and update the user characteristic information based on acceptance or rejection of the candidate reply and on editing content applied to the candidate reply.

### Application Example 2

### (Supplementary 1)

A system comprising a processor,
wherein the processor is configured to
acquire user attribute information and past communication history, and analyze the attribute information and the communication history by using natural language processing technology and an emotion analysis function so as to identify an emotional state and a behavioral tendency of a user,
construct a prompt sentence for input to a generative information processing model on the basis of the emotional state of the user, the behavioral tendency of the user, and context information related to an information providing content or a communication situation being used by the user, and transmit the prompt sentence to the generative information processing model so as to cause the generative information processing model to generate response information,
transmit the response information generated by the generative information processing model to a user terminal via a communication function of an external communication infrastructure or an information providing infrastructure, transmit the response information to a counterpart or to the information providing infrastructure in place of the user, and present related information or recommend information by using the response information,
track a temporal change of the emotional state of the user, and adjust an expression style and a dialogue tone of the response information in accordance with the temporal change, and
accumulate usage history indicating whether the user has approved or modified the response information, and update a generation method of the prompt sentence or a generation condition of the response information on the basis of the usage history.

### (Supplementary 2)

The system according to supplementary 1,
wherein the processor is configured to dynamically generate the prompt sentence by integrating a plurality of types of context information including the user attribute information, the emotional state of the user, the behavioral tendency of the user, information related to content being viewed or used by the user, and summary information of past dialogue history, and by including, in the prompt sentence, an instruction for causing the generative information processing model to generate at least one of a reply text, a question text, a comment text, and a recommendation explanation text.

### (Supplementary 3)

The system according to supplementary 1,
wherein the processor is configured to cooperate with a communication function of an information exchange service or an information distribution service, determine that a state of the user is a busy state or a response-difficult state, and, in accordance with presence or absence of approval from the user, automatically transmit the response information generated by the generative information processing model or transmit the response information after presentation to the user, thereby executing continuous dialogue or interaction in place of the user.

What is claimed is:

1. A system comprising:
a communication interface coupled to a packet-switched network; and
circuitry configured to:
acquire, via the communication interface, communication data and user attribute data associated with a user identifier from a storage device;
analyze the communication data by executing a natural language processing operation to extract a keyword set and topic information, and recognize an emotional state of the user by executing an emotion analysis algorithm on the communication data;
generate a prompt sentence based on the keyword set, the topic information, the emotional state, and content data received from a counterpart device, the prompt sentence comprising structured fields specifying a personality parameter, a context parameter, and a response constraint;
transmit the prompt sentence to a generative neural network model via the communication interface and receive, from the generative neural network model, response candidate text data; and
perform a filtering operation and a formatting operation on the response candidate text data based on a content restriction rule stored in the storage device to produce output text data, and transmit the output text data to a terminal device via the communication interface.

2. The system according to claim 1, wherein the circuitry is configured to convert the communication data into a vector representation by executing an embedding model, derive the topic information by applying a clustering algorithm to the vector representation, and dynamically select a subset of the topic information for inclusion in the prompt sentence.

3. The system according to claim 2, wherein the circuitry is configured to divide the communication data into linguistic units and part-of-speech units, compute occurrence frequency values for each unit, and remove units having an occurrence frequency below a threshold to extract the keyword set.

4. The system according to claim 3, wherein the prompt sentence is generated by inserting the keyword set, the topic information, the emotional state, and the content data into a template data structure comprising a personality tendency field, a conversation context field, a writing style field, and a response length field.

5. The system according to claim 4, wherein the circuitry is configured to apply a sentiment scoring function to successive instances of the communication data to compute an emotional state time series, and adjust a tone parameter of the prompt sentence in response to a detected change in the emotional state time series.

6. The system according to claim 1, wherein the circuitry is configured to receive, via the communication interface, updated communication data and user interaction data indicating acceptance, rejection, or editing of previously generated output text data, and update the user attribute data in the storage device based on the user interaction data.

7. The system according to claim 6, wherein the circuitry is configured to modify at least one of the personality parameter, the context parameter, and the response constraint in a subsequent prompt sentence based on a pattern derived from accumulated user interaction data stored in the storage device.

8. The system according to claim 7, wherein the circuitry is configured to maintain an interaction history comprising a sequence of prior prompt sentences and corresponding response candidate texts in the storage device, and incorporate at least a portion of the interaction history into a subsequent prompt sentence.

9. The system according to claim 8, wherein the generative neural network model comprises a transformer architecture having a plurality of self-attention layers, and the circuitry is configured to set inference parameters comprising at least a temperature value and a maximum output token count prior to transmitting the prompt sentence.

10. The system according to claim 1, wherein the filtering operation comprises at least one of: detecting an inappropriate expression in the response candidate text data by applying a classification model, adjusting a length of the response candidate text data to satisfy a maximum character count, and normalizing a format of the response candidate text data to match a predefined output schema.

11. The system according to claim 1, wherein the circuitry is configured to analyze the communication data using a semantic analysis operation executed by the generative neural network model to extract intent information comprising at least one of a request type, a topic category, and a sentiment polarity value.

12. The system according to claim 11, wherein the circuitry is configured to acquire preference information associated with the user identifier from the storage device and integrate the preference information with the intent information and the topic information to generate the prompt sentence.

13. The system according to claim 12, wherein the circuitry is configured to detect an anomaly in the response candidate text data by computing a deviation metric between the response candidate text data and expected output parameters derived from the communication data, and trigger regeneration of the response candidate text data when the deviation metric exceeds a threshold value.

14. The system according to claim 13, wherein the regeneration comprises modifying the prompt sentence to include an indication of the detected anomaly and retransmitting the modified prompt sentence to the generative neural network model.

15. The system according to claim 1, wherein the circuitry is configured to compute, based on the user interaction data, an acceptance rate metric indicating a ratio of accepted output text data to total generated output text data, and adjust a generation condition of the prompt sentence when the acceptance rate metric falls below a predetermined threshold.

16. The system according to claim 1, wherein the circuitry is configured to track a temporal change of the emotional state across a plurality of communication sessions and adjust an expression style parameter and a dialogue tone parameter of the response candidate text data in accordance with the temporal change.

17. The system according to claim 1, wherein the user attribute data comprises at least one of: demographic data, behavioral tendency data derived from past communication patterns, and preference data indicating topic affinity scores computed from the communication data.

18. A system comprising:
a communication interface coupled to a packet-switched network; and
circuitry configured to:
acquire, via the communication interface, communication data and user attribute data associated with a user identifier from a storage device;
execute a natural language processing operation on the communication data to extract intent information, topic information, and keyword information;
recognize an emotional state of the user by executing an emotion analysis algorithm, and track a temporal change of the emotional state across successive instances of the communication data;
convert the communication data into a vector representation by executing an embedding model and derive topic clusters by applying a clustering algorithm;
generate a prompt sentence comprising structured fields populated with the intent information, the topic information, the keyword information, the emotional state, and user characteristic information derived from the user attribute data;
transmit the prompt sentence to a generative neural network model comprising a transformer architecture via the communication interface and receive response candidate text data;
perform a filtering operation on the response candidate text data comprising inappropriate expression detection, length adjustment, and format normalization;
transmit filtered output text data to a terminal device via the communication interface; and
update the user attribute data in the storage device based on user interaction data indicating acceptance or modification of the output text data.

19. The system according to claim 18, wherein the circuitry is configured to train the embedding model using a training dataset derived from the communication data, the training applying a contrastive loss function to learn vector representations that preserve semantic similarity between related communication segments.

20. A method comprising:
acquiring, via a communication interface coupled to a packet-switched network, communication data and user attribute data associated with a user identifier from a storage device;
analyzing the communication data by executing a natural language processing operation to extract a keyword set and topic information, and recognizing an emotional state of a user by executing an emotion analysis algorithm on the communication data;
generating a prompt sentence based on the keyword set, the topic information, the emotional state, and content data received from a counterpart device, the prompt sentence comprising structured fields specifying a personality parameter, a context parameter, and a response constraint;
transmitting the prompt sentence to a generative neural network model via the communication interface and receiving, from the generative neural network model, response candidate text data;
performing a filtering operation and a formatting operation on the response candidate text data based on a content restriction rule stored in the storage device to produce output text data; and
transmitting the output text data to a terminal device via the communication interface.
